(19) United States
(12) Patent Application Publication
(10) Pub. No.: US 2025/0374932 A1
(43) Pub. Date: Dec. 11, 2025

(54) FERMENTED PLANT AND MICROBIAL-BASED FOOD PRODUCTS

(71) Applicant: The Cheese Design LLC, Benicia, CA (US)

(72) Inventor: Cecylia SZEWCZYK, Hercules, CA (US)

(21) Appl. No.: 19/213,338

(22) Filed: May 20, 2025

Related U.S. Application Data
(63) Continuation of application No. PCT/US2023/080490, filed on Nov. 20, 2023.
(60) Provisional application No. 63/427,059, filed on Nov. 21, 2022.

(51) Int. Cl. A23C 20/02; A23L 29/256

(52) U.S. Cl. CPC A23C 20/025; A23L 29/256

(57) ABSTRACT

Described herein are non-dairy food products and methods for producing non-dairy food products using plant whole food nutrient bases and hydrocolloid fibers. The use of hydrocolloid fibers enhances the quality of non-dairy food products, such as cheese, providing a process for increased protein content compared to alternative non-dairy food products, as well as providing taste and physical properties comparable to dairy cheeses.

### CROSS-REFERENCE TO RELATED APPLICATION

This application is a continuation of International Patent Application No. PCT/US2023/080490, filed Nov. 20, 2023, which application claims priority to U.S. Provisional Application No. 63/427,059, filed Nov. 21, 2022, the entire contents of both are incorporated herein by reference.

### TECHNICAL FIELD

Described herein, are non-dairy food products and methods for producing the non-dairy food products using non-dairy nutrient bases and hydrocolloid fibers. Specifically, the present disclosure provides, among other things, non-dairy cheese products and methods of making the same.

### BACKGROUND

The following description of the background of the present technology is provided simply as an aid in understanding the present technology and is not admitted to describe or constitute prior art to the present technology.

Non-animal food products (e.g., non-dairy cheese) have become a highly desired alternative to the animal product (e.g., dairy cheese) as they eliminate the need for animal cultivation, animal breeding programs, and animal slaughter. Many dairy cheeses, particularly natural cheeses (i.e., fermented or unprocessed cheese that contains a live flora) with an elastic and functional texture (e.g., slice-able, shred-able, etc.), can be prepared by processes that involve adding protease to a dairy milk, thus causing enzymatic coagulation of casein micelles. The protease cleaves glycomacropeptides from the casein micelles, depriving the casein micelles of a negative charge, which keeps the micelles suspended in the milk. The casein micelles collapse into a coagulated network (e.g., a curd or gel) that captures the macro elements (e.g., fats, water, and proteins) and micro elements of the milk solution into the coagulated structure.

Using non-animal ingredients to produce a similar non-animal food product, such as non-dairy cheese, has proven difficult. Indeed, currently available non-dairy and animal-free cheeses generally possess a significantly lower protein content (with most at 0% level) and lack many of the defining characteristics of certain cheeses (e.g., natural cheeses) as well as certain cheese functionalities (e.g., elasticity, chewiness, meltability, sliceability, shred-ability, springiness, etc.). The presently disclosed food products and methods overcome the deficiencies of currently available non-dairy and animal-free cheeses.

### SUMMARY

The present disclosure provides non-dairy cheeses and methods of making the same. The disclosed non-dairy cheeses are formed from a nutrient base (e.g., a nut or seed milk) and a hydrocolloid fiber. Among other benefits, the disclosed use of hydrocolloid fibers allows for full fermentation of the product, enhances the quality of non-dairy food products (e.g., non-dairy cheese) by providing a process for significantly increased protein content relative to comparable, alternative non-dairy food products, and provides textural properties like elasticity, chewiness, springiness as well as functional properties like meltability, sliceability, and shred-ability that are comparable to enzymatically coagulated dairy cheese.

One aspect, the present disclosure provides a food product, comprising a hydrocolloid fiber and a coagulated and fermented non-dairy nutrient base that is coagulated with the hydrocolloid fiber, wherein the food product comprises a protein content (e.g., a non-dairy protein) in an amount greater than or equal to 15% by weight based on total weight of the food product (% w/w). In some embodiments, the non-dairy nutrient base further comprises at least one plant-or microbial-based oil. In some embodiments, the at least one plant-or microbial-based oil comprises a solid fat content (SFC) curve that is similar to anhydrous milk fat (AMF) or lard. For example, the SFC curve may be +/−20% (e.g., +/−5%, 10%, 15%, or 20%) of a SFC curve of anhydrous milk fat (AMF) or lard at 10° C., +/−20% (e.g., +/−5%, 10%, 15%, or 20%) of a SFC curve of AMF or lard at 15° C., +/−10% (e.g., +/−5% or 10%) of a SFC curve of AMF or lard at 20° C., +/−10% (e.g., +/−5% or 10%) of a SFC curve of AMF or lard at 25° C., +/−10% (e.g., +/−5% or 10%) of a SFC curve of AMF or lard at 30° C., +/−10% (e.g., +/−5% or 10%) of a SFC curve of AMF or lard at 35° C., and/or +/−10% (e.g., +/−5% or 10%) of a SFC curve of AMF or lard at 40° C.

In another aspect, the present disclosure provides a food product, comprising a hydrocolloid fiber, a coagulated and fermented non-dairy nutrient base that is coagulated with the hydrocolloid fiber, and at least one plant-or microbial-based oil, wherein the at least one plant-or microbial-based oil comprises a solid fat content (SFC) curve that is high in solid fat content in the temperature range between 10° C. and 30° C. For example the SFC curve may be with +/−60% (e.g., +/−5%, 10%, 15%, 20%, 30%, 40%, 50%, or 60%) of a SFC curve of anhydrous milk fat (AMF) or lard at 10° C., +/−60% (e.g., +/−5%, 10%, 15%, 20%, 30%, 40%, 50%, or 60%) of a SFC curve of AMF or lard at 15° C., +/−60% (e.g., +/−5%, 10%, 15%, 20%, 30%, 40%, 50%, or 60%) of a SFC curve of AMF or lard at 20° C., +/−50% (e.g., +/−5%, 10%, 15%, 20%, 30%, 40%, or 50%) of a SFC curve of AMF or lard at 25° C., +/−50% (e.g., +/−5%, 10%, 15%, 20%, 30%, 40%, or 50%) of a SFC curve of AMF or lard at 30° C., +/−20% (e.g., +/−5%, 10%, 15%, or 20%) of a SFC curve of AMF or lard at 35° C., +/−10% (e.g., +/−5% or 10%) of a SFC curve of AMF or lard at 40° C., or any combination thereof. In some embodiments, the SFC curve is +/−10% of a SFC curve of anhydrous milk fat (AMF) or lard at 10° C., +/−10% of a SFC curve of AMF or lard at 15° C., +/−10% of a SFC curve of AMF or lard at 20° C., +/−10% of a SFC curve of AMF or lard at 25° C., +/−10% of a SFC curve of AMF or lard at 30° C., +/−10% of a SFC curve of AMF or lard at 35° C., +/−10% of a SFC curve of AMF or lard at 40° C., or any combination thereof. In some embodiments, the food product comprises a protein content (e.g., a non-dairy protein) in an amount greater than or equal to 15% w/w.

In some embodiments, the at least one plant-or microbial-based oil may be selected from shea butter, shea olein, shea stearin, illipe fat, coco butter, sal butter, coconut oil, coconut stearin, palm oil, palm stearin, palm olein, palm kernel, pongamia oil, and any combination thereof. In some embodiments, the at least one plant- or microbial-based oil comprises about 5% to about 70% of a stearin shea fraction and about 30% to about 95% of an olein shea fraction. In some embodiments, the at least one plant- or microbial-based oil comprises about 20% to about 40% of a stearin shea fraction and about 60% to about 80% of an olein shea fraction. In some embodiments, the plant-or microbial-based oil is present in an amount between about 10% to about 30% w/w of the coagulated food product.

In some embodiments, the food product is a cheese.

In some embodiments, the fermented non-dairy nutrient base is a fermented plant milk or a fermented microbial-based milk. In some embodiments, the fermented plant milk comprises (i) water, and (ii) milled seeds, milled nuts, milled beans, milled grains, milled vegetables, or a combination thereof. In some embodiments, the fermented plant milk is selected from soybean milk, lupini bean milk, almond milk, hemp seed milk, melon seed milk, pumpkin seed milk, oat milk, pea milk, fava bean milk, chickpea milk, sunflower seed milk, edamame milk, lentil milk, pistachio milk, peanut milk, walnut milk, cashew milk, coconut milk, watermelon seed milk, and macadamia milk.

In some embodiments, the hydrocolloid fiber is selected from a fiber extract from seaweed, a fiber extract from an algae (e.g., macroalgae or microalgae), acacia gum, locust bean gum, guar gum, pectin, cellulose or a cellulose derivative, konjac, alginate (e.g., sodium alginate), carrageenan (e.g., K-carrageenan), gellan gum, agar, pullulan, dextran, curdlan, levan, and xanthan. In some embodiments, the algae is selected from Rhodophyceae algae, Phaeophyceade algae, or Chlorophyceae algae. In some embodiments, the hydrocolloid fiber is a fiber extract from a microorganism of a genus selected from Xanthomonas, Sphingomonas, Pseudomonas, Aureobasidium, Streptococcus, Leuconostoc, Acetobacter, Azotobacter, Pseudomonas, Alcaligenes, Bacillus, Zymomonas, Aerobacter, Acetobacter, Actinomyces, Erwinia, Rhanella, Lactobacillus, Microbacterium, and Serratia.

In some embodiments, the hydrocolloid fiber forms a synergetic gel.

In some embodiments, the hydrocolloid fiber is about 1.0% w/w or less (e.g., 0.9% w/w, 0.8% w/w, 0.7% w/w or less) of the coagulated food product.

In some embodiments, the protein content (e.g. the non-dairy protein amount) is greater than or equal to about 20% w/w.

In some embodiments, a protein isolate or a protein concentrate is not added to increase protein content. For example, a protein isolate or a protein concentrate is not added to the non-dairy nutrient base or the food product, either before, during, or after fermentation.

In some embodiments, the coagulated food comprises only whole plant foods as ingredients and a hydrocolloid fiber.

In some embodiments, the coagulated food product consists of 8 or fewer ingredients.

In some embodiments, the food product has a complex modulus (G*) between about 30000 PA and about 50000 PA at a frequency of 2-20 HZ. In some embodiments, the food product has a phase angle (Δ) between about 8 and about 16 at a frequency of 2-20 HZ. In some embodiments, the food product has a cut force slope of less than 1.5 N/s (e.g., between 1-1.5 N/s). For the purposes of these embodiments and other physical properties of the disclosed food products, the properties can be measured as shown in Example 7.

In some embodiments, the food product is fully fermented. In some embodiments, the fermented non-dairy nutrient base is fermented with mesophilic or thermophilic bacteria.

In another aspect, the present disclosure provides a method of producing a food product, comprising:
(a) inoculating a non-dairy nutrient base with at least one microbial culture;
(b) adding at least one hydrocolloid fiber to the non-dairy nutrient base inoculated with the at least one microbial culture, thereby inducing coagulation and formation of a curd;
(c) removing water from the curd such that protein content of the curd is at least two times higher than protein content of the non-dairy nutrient base of a w/w basis; and
(d) aging the curd to allow fermentation of the non-dairy nutrient base by the at least one microbial culture.

In some embodiments, the methods may further comprise shaping the curd prior to aging the curd, wherein the shape is optionally a wheel, loaf, or a block.

In some embodiments, the methods may further comprise acidification or brining of the curd after removing water and prior to aging the curd.

In some embodiments, the methods may further comprise coating the curd with a water-permeable material immediately prior to aging the curd.

In some embodiments, the curd is shaped in a microperforated cheese mold.

In some embodiments, aging the curd is performed at a relative humidity of between about 20% to about 85% and, optionally, a temperature between about 10° C. to about 22° C.

In some embodiments, the methods may further comprise adding fermentation promotors or natural flavoring agents to the non-dairy nutrient base. In some embodiments, the fermentation promotors are selected from sauerkraut, miso, and nutritional yeast.

In some embodiments, the methods may further comprise filtering or separation of the non-dairy nutrient base to remove solid particles prior to adding the at least one hydrocolloid fiber.

In some embodiments, the methods may further comprise contacting the non-dairy nutrient base with a protease, an amino peptidase, an amylase, a cellulase, a hemicellulose, or a combination thereof prior to adding the at least one hydrocolloid fiber.

In some embodiments, the non-dairy nutrient base further comprises at least one plant-or microbial-based oil to the non-dairy nutrient base. In some embodiments, the at least one plant-or microbial-based oil comprises a solid fat content (SFC) curve that is +/−20% of a SFC curve of anhydrous milk fat (AMF) or lard at 10° C., +/−20% of a SFC curve of AMF or lard at 15° C., +/−10% of a SFC curve of AMF or lard at 20° C., +/−10% of a SFC curve of AMF or lard at 25° C., +/−10% of a SFC curve of AMF or lard at 30° C., +/−10% of a SFC curve of AMF or lard at 35° C., and/or +/−10% of a SFC curve of AMF or lard at 40° C. In some embodiments, the SFC curve is curve that is +/−10% of a SFC curve of anhydrous milk fat (AMF) or lard at 10° C., +/−10% of a SFC curve of AMF or lard at 15° C., +/−10% of a SFC curve of AMF or lard at 20° C., +/−10% of a SFC curve of AMF or lard at 25° C., +/−5% of a SFC curve of AMF or lard at 30° C., +/−5% of a SFC curve of AMF or lard at 35° C., and/or +/−5% of a SFC curve of AMF or lard at 40° C. In some embodiments, the at least one plant-or microbial-based oil is selected from shea butter, shea olein, shea stearin, illipe fat, coco butter, sal butter, coconut oil, coconut stearin, palm oil, palm stearin, palm olein, palm kernel, pongamia oil, and any combination thereof.

In some embodiments, the at least one microbial culture is selected from a thermophilic bacterial starter culture or a mesophilic bacterial starter culture. In some embodiments, the at least one microbial culture is selected from lactic acid bacteria, propionic acid bacteria, acetic acid bacteria, or yeast.

In some embodiments, the curd, after removing water, has a protein content of greater than or equal to 12% w/w, greater than or equal to 15% w/w, or greater than or equal to 20% w/w.

In some embodiments, the non-dairy nutrient base has a pH of 5.2 or less (e.g., 5.0, 4.5, etc.) prior to adding the at least one hydrocolloid fiber.

In some embodiments, the non-dairy nutrient base is a plant-based milk. In some embodiments, the plant milk comprises (i) water, and (ii) milled seeds, milled nuts, milled beans, milled grains, milled vegetables, or a combination thereof. In some embodiments, the non-dairy nutrient base comprises at least 60%, at least 65%, at least 70% at least 75%, or at least 80% w/w of water when the non-dairy nutrient base is inoculated with the at least one microbial culture. In some embodiments, the non-dairy nutrient base is selected from soybean milk, lupini bean milk, almond milk, hemp seed milk, melon seed milk, pumpkin seed milk, oat milk, pea milk, fava bean milk, chickpea milk, sunflower seed milk, edamame milk, lentil milk, pistachio milk, peanut milk, walnut milk, cashew milk, coconut milk, watermelon seed milk, and macadamia milk.

In some embodiments, the hydrocolloid fiber forms a synergetic gel.

In some embodiments, the hydrocolloid fiber is selected from a fiber extract from seaweed, a fiber extract from an algae (e.g., macroalgae or microalgae), acacia gum, locust bean gum, guar gum, pectin, cellulose or a cellulose derivative, konjac, alginate (e.g., sodium alginate), carrageenan (e.g., κ-carrageenan), gellan gum, agar, pullulan, dextran, curdlan, levan, and xanthan. In some embodiments, the algae is selected from Rhodophyceae algae, Phaeophyceade algae, or Chlorophyceae algae. In some embodiments, the hydrocolloid fiber is a fiber extract from a microorganism of a genus selected from Xanthomonas, Sphingomonas, Pseudomonas, Aureobasidium, Streptococcus, Leuconostoc, Acetobacter, Azotobacter, Pseudomonas, Alcaligenes, Bacillus, Zymomonas, Aerobacter, Acetobacter, Actinomyces, Erwinia, Rhanella, Lactobacillus, Microbacterium, and Serratia.

In some embodiments, the method does not comprise adding a protein isolate or protein concentrate to the non-dairy nutrient base, the curd, or both.

In another aspect, the present disclosure provides a method of solid-state fermentation, comprising: coagulating a non-dairy nutrient base by contacting the non-dairy nutrient base with at least one hydrocolloid fiber to form a solid or gel; inoculating the non-dairy nutrient base with at least one microbial culture; and incubating or aging the solid or gel to allow fermentation of the non-dairy nutrient base by the at least one microbial culture in a solid-state. Such solid-state fermentation is novel for non-dairy products such as those disclosed herein, and it is distinct from products that ferment a liquid and later coagulate or stabilize a liquid after fermentation. In some embodiments, during incubation, the non-dairy nutrient base is dehydrated at a dehydration rate consistent with a dehydration rate of dairy milk when incubating dairy cheese. In some embodiments, during incubation, the non-dairy nutrient base is acidified at an acidification rate consistent with an acidification rate of dairy milk when incubating dairy cheese. In some embodiments, the at least one microbial culture is a mesophilic bacteria or a thermophilic bacteria. In some embodiments, the method does not comprise adding a protein isolate or protein concentrate to the non-dairy nutrient base, the curd, or both.

In another aspect, the present disclosure provides a food product obtained by the methods disclosed herein. In some embodiments, the food product is a cheese. In some embodiments, the food product comprises only whole plant foods and a hydrocolloid fiber as ingredients. In some embodiments, the food product consists of 8 or fewer ingredients. In some embodiments, the food product has a protein content of greater than or equal to 15% w/w, or optionally greater than or equal to 20% w/w. In other words, the food product may contain a non-dairy protein or non-dairy proteins in an amount greater than or equal to 15% w/w, or optionally greater than or equal to 20% w/w.

The foregoing general description and following detailed description are exemplary and explanatory and are intended to provide further explanation of the disclosure as claimed. Other objects, advantages, and novel features will be readily apparent to those skilled in the art from the following brief description of the drawings and detailed description of the disclosure.

### BRIEF DESCRIPTION OF THE DRAWINGS

FIG. 1 depicts a flowchart of the hydrocolloid fiber extraction process.

FIG. 2 shows a table comparing alternative plant or microbial-based cheese products.

FIG. 3 shows a magnified photo of a curd formed from casein (Panel A) compared to a hydrocolloidal fiber network created in an aqueous solution (Panel B).

FIGS. 4A-4B depict coagulation in a microperforated cheese mold (FIG. 4A), and the weight of the cheese wheel post-aging and pre-aging, which shows the significant concentration that occurs during aging (FIG. 4B).

FIG. 5 depicts an aged wheel of non-dairy cheese product.

FIGS. 6A-6B depict exemplary examples of non-dairy cheese cross sections with openings from microbial gas production indicating natural fermentation.

FIGS. 7A-7C depict the slice-ability and shred-ability of the non-dairy cheese product (FIG. 7A), depicts the crumbly texture (feta-like) of the non-dairy cheese product that results when milk is acidified to a pH <4.5 before coagulation (FIG. 7B), and depicts the shred-ability of the non-dairy cheese product (FIG. 7C).

FIGS. 8A-8I depict improved elasticity properties of the non-dairy cheese product compared to alternative non-dairy cheese products. Improved elasticity of a slice of non-dairy cheese product (FIG. 8A) and improved elasticity of a thick slice of non-dairy cheese product (FIG. 8B) compared to the elasticity of a slice of Miyoko's Kitchen plant-based processed cheddar style cheese (FIG. 8C) and Daiya's plant-based cheddar style cheese (FIG. 8D). A cheese plug (trier) used for elastic texture measurements (FIG. 8E). A trier of non-dairy cheese product demonstrating elastic texture (FIG. 8F and 8G) compared with the elastic texture of Miyoko's Kitchen plant-based processed cheddar style cheese (FIG. 8H) and Daiya's plant-based cheddar style cheese (FIG. 8I).

FIG. 9 demonstrates the melting ranges of shea fraction blends compared to anhydrous milk fat (AMF), lard, and coconut oil.

FIG. 10 demonstrates the melting ranges of various shea fraction blends compare to anhydrous milk fat (AMF).

FIG. 11 demonstrates how a plant or microbial-based milk may be produced.

FIG. 12 demonstrates how a plant or microbial-based milk may be processed into a plant or microbial based cheese or similar food product. Similar processing can be used to produce plant-based “meats,” plant-based “fish,” and other plant-based high-protein food products or fermented foods.

FIG. 13 demonstrates the acidification profile of three examples of hemp-based non-dairy cheeses.

FIG. 14 demonstrates dehydration/concentration rate of three examples of aged hemp-based non-dairy cheeses.

FIG. 15 shows standard average composition of selected dairy cheese published by Center for Dairy Research, UW.

FIG. 16 shows acidification results for trials using mesophilic cultures for fermentation.

FIG. 17 shows acidification results for trials using thermophilic cultures for fermentation.

FIG. 18 shows the impact of miso subtraction on acidification.

FIG. 19 shows impact of sour kraut subtraction on acidification.

FIG. 20 shows the impact of dextrose supplementation on acidification.

FIG. 21 shows the impact of saccharolytic enzymes (hemicellulase and α-amylase) subtraction on acidification.

FIG. 22 shows the relative carbohydrate (starch+fiber) content of whole foods used for plant-based milk preparation.

FIG. 23 shows a comparison of cheese acidification profile obtained with a hemp only formula at 20% & 25% DM.

FIG. 24 shows a comparison of cheese acidification profile obtained with reference formula at 20% & 25% DM.

FIG. 25 shows CHN19 acidification profile comparison in 25% DM hemp milk pasteurized to 65° C. or 85° C.

FIG. 26 illustrates phase angle, viscous, elastic modulus & complex modulus.

FIG. 27 shows a comparison of complex modulus (stiffness/elasticity) measurement in various tested samples as compared to dairy Gouda cheese.

FIG. 28 shows averages of triplicate readings per sample of phase angle measurements in various tested samples as compared to dairy Gouda cheese.

FIG. 29 shows vertical compression test results, illustrating the chewiness of tested cheeses.

FIG. 30 shows the extensibility of several tested non-dairy cheeses compared to diary Gouda cheese.

FIG. 31 shows the toughness of several tested non-dairy cheeses compared to diary Gouda cheese.

FIG. 32 shows the stiffness of several tested non-dairy cheeses compared to diary Gouda cheese.

FIG. 33 shows the firmness of several tested non-dairy cheeses compared to diary Gouda cheese.

FIG. 34 shows a comparison of the cutting force needed to cut through various tested non-dairy cheeses and dairy Gouda.

FIG. 35 shows a rank order of the cutting force slope as applied throughout the slicing of various tested cheeses

FIG. 36 shows the acidification profiles of cheeses made with lupine bean, melon seed, and almond.

FIG. 37 shows dehydration rates of cheeses made with lupine bean, melon seed, and almond.

FIG. 38 shows acidification profiles of cheeses coagulated with agar, alginate, and carrageenan.

FIG. 39 shows dehydration profiles of cheeses coagulated with agar, alginate, and carrageenan.

FIG. 40 shows the standard SFC content profiles of natural animal and plant fats.

FIG. 41 shows the SFC profiles of fat blends prepared for obtaining various fat blend characteristics.

FIG. 42 shows the SFC profiles of fat blends in comparison to AMF (anhydrous milk fat).

### DETAILED DESCRIPTION

Dairy cheeses possess several defining characteristics. The curd or gel undergoes a high level of syneresis, which is the expulsion of excess fluid. This results in concentrating effect of the milk from which the cheese is made and can provide an approximately ten-fold or more increase in the relative amount of fat and protein in the curd compared to the original milk product. On average, dairy cheese products are about 19-22% protein compared to dairy milk, which is only approximately 2.8-3.4% protein. Dairy cheese also contains concentrated fat that is characterized by high solid fat content at room temperatures (i.e., 15-20° C.), and gradual melting of solid fat crystals that results in flavor release at human body temperature. Further, dairy cheese products display a high degree of elasticity and are generally easily sliceable and shred-able. Lastly, the curd or gel holds free and chemically unbound water that allows fermentation and biodegradation to occur during aging.

Currently available non-dairy cheese products come in the form of spreads or processed blocks of plant or microbial based cheeses. Spreadable non-dairy cheeses contain a low amount of protein (e.g., <10%) and are typically not slice-able, shred-able, or crumble-able. The processed blocks mainly comprise starches and fats and generally have little or no protein content. To achieve a protein level of dairy cheeses in currently available non-dairy cheese product, protein concentrates and isolates are added, but this results in a bad taste that needs to be “masked” with added flavors and the overall protein content is still generally much lower than dairy cheese. Thus, currently available non-dairy cheese products are a poor alternative to the animal product.

Further, most non-dairy cheese that is currently on the market is not fermented, and therefore preservatives must be used to obtain stable quality and exogenous flavorants must be added to provide a flavor notes reminiscent of a cheese product. There are few exceptions where a liquid base is subjected to fermentation, and then processed as ingredient with starch under high heat, but even these non-dairy cheeses are not fully fermented, in that additional processes are required and ingredients are added after fermentation has ceased.

The present disclosure provides methods of using hydrocolloid fiber as a solution to this problem. The use of hydrocolloids fibers that form networks in an aqueous environment (e.g., a plant milk) allows for the formation of a curd in which a high degree of syneresis can occur and in which unbound water is held to allow for fermentation and biodegradation. The presently disclosed methods and products utilize syneresis in a way that is comparable to the process of making dairy cheese, whereas currently available non-dairy cheese have generally been produced via processes that actively avoided syneresis.

The present disclosure is the first to show that applying fibrous extracts to non-dairy nutrient bases allows for the formation of a synergetic gel (i.e., curd), water encapsulation, and subsequent syneresis of the water. The ability of the fibrous extract to gradually expel the encapsulated water provides a previously unobtainable way to concentrate the protein found in non-dairy nutrient bases, such as nut milk, seed milk, or bean milk, and it allows to produce a high protein non-dairy product. Moreover, the product can be produced entirely by fermentation, without any further processing or ingredients required after fermentation is complete, though in some instances, additional processing or ingredient may be desired. The resulting product has exceptional texture and elasticity, and it can be easily sliced and shredded, without added protein isolates, starches, or fats. Another advantage to this technique, is the use of hydrocolloid fibers does not require high temperature treatment of the non-dairy plant or microbial base. Rather, the disclosed processes can utilize cold coagulation, which allows for inoculation (i.e., culture addition) in temperature range that is viable for most mesophilic and thermophilic starter cultures. Thus, the non-dairy food product can be produced in a natural, unprocessed way allowing for proper fermentation, preservation, and product maturation.

### DEFINITIONS

Embodiments according to the present disclosure will be described more fully hereinafter. Aspects of the disclosure may, however, be embodied in different forms and should not be construed as limited to the embodiments set forth herein. Rather, these embodiments are provided so that this disclosure will be thorough and complete, and will fully convey the scope of the invention to those skilled in the art. The terminology used in the description herein is for the purpose of describing particular embodiments only and is not intended to be limiting.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. Although not explicitly defined below, such terms should be interpreted according to their common meaning.

The terminology used in the description herein is for the purpose of describing particular embodiments only and is not intended to be limiting of the invention. All publications, patent applications, patents and other references mentioned herein are incorporated by reference in their entirety.

The practice of the present technology will employ, unless otherwise indicated, conventional techniques of molecular biology, microbiology, chemical engineering, cell biology, and food science which are within the skill of the art.

Unless the context indicates otherwise, it is specifically intended that the various features of the disclosure described herein can be used in any combination. Moreover, the disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

All numerical designations, e.g., pH, temperature, time, concentration, and molecular weight, including ranges, are approximations which are varied (+) or (−) by increments of 1.0 or 0.1, as appropriate, or alternatively by a variation of +/−15%, or alternatively 10%, or alternatively 5%, or alternatively 2%. It is to be understood, although not always explicitly stated, that all numerical designations are preceded by the term “about”. It also is to be understood, although not always explicitly stated, that the reagents described herein are merely exemplary and that equivalents of such are known in the art.

As used in the description of the invention and the appended claims, the singular forms “a,” “an” and “the” are intended to include the plural forms as well, unless the context clearly indicates otherwise.

As used herein, the term “about” means the recited quantity exactly and variations within a limited range encompassing plus or minus 10% of the recited quantity. In other words, the limited range encompassed can include ±10%, ±9%, ±8%, ±7%, ±6%, ±5%, ±4%, ±3%, ±2%, ±1%, ±0.5%, ±0.2%, ±0.1%, ±0.05%, or smaller, as well as the recited value itself. Thus, by way of example, “about 10” should be understood to mean “10” and a range no larger than “9-11”.

As used herein, the terms “acceptable,” “effective,” or “sufficient” refer to the selection of any components, ranges, dose forms, etc. disclosed herein intend that said component, range, dose form, etc., is suitable for the disclosed purpose.

Also as used herein, “and/or” refers to and encompasses any and all possible combinations of one or more of the associated listed items, as well as the lack of combinations when interpreted in the alternative (“or”).

As used herein, the term “fermented” refers to a food product that has undergone an anaerobic or aerobic process by which a microbial culture (e.g., bacteria or yeast) converts carbohydrates to organic acids, gases, or alcohol and converts citrates to aromatic compounds (e.g., diacetyl and acetoin).

As used herein, the term “curd” refers to an intermediate of a food product (i.e., cheese) that has been converted from a liquid to a solid mass. A curd may be produced when milk (e.g., plant milk) or another nutrient base as disclosed herein undergoes coagulation, which can occur as a result of enzyme action, acid addition, or acid/heat addition.

As used herein, the term “hydrocolloid fiber” refers to a heterogeneous group of high molecular weight, long chain hydrophilic polymer agents that can perform gelling, maintain free and chemically unbound water, and show high degree of syneresis.

As used herein, the term “non-dairy nutrient base” refers to non-dairy milk, such as a plant milk or a microbial-based milk.

As used herein, the terms “plant milk” or “plant-based milk” may be used interchangeably to refer to a non-dairy milk alternative produced from milled plants. In general, such milks will comprise (i) water, and (ii) milled seeds, milled nuts, milled beans, milled grains, milled vegetables, or a combination thereof. Non-limiting examples of seeds, nuts, beans, and grains that may be made into milk include from soybean, lupini bean, almond, hemp seed, melon seed (e.g., watermelon seed), pumpkin seed, oat, pea, fava bean, chickpea, sunflower seed, edamame, lentil, pistachio, peanut, walnut, cashew, coconut, and macadamia nut.

As used herein, the term “microbial-based milk” refers to a non-dairy milk alternative produced from microbes including but not limited to bacteria, yeast, and algae. For example, microbial-based milk may be produced from proteins obtained from GM & non GM microbial biomass cultivation.

As used herein, the term “plant-based oil” refers to oils derived from plant sources. There are three types of plant oil determined by the process of extracting the oil and in the nature of the resulting oil. For example, vegetable oils are extracted by placing certain parts of the plant under pressure and squeezing out the oil.

As used herein, the term “microbial-based oils” refers to oils extracted from microbes, including but not limited to bacteria, yeast, and algae.

As used herein, the term “synergetic gel” refers to a gel formed by hydrocolloid fibers capable of expelling water.

As used herein, the term “acidification” refers to inoculating a starter culture to milk (e.g., plant milk) or another nutrient base as disclosed herein to convert a sugar to an acid (e.g., lactose into lactic acid).

As used herein, the term “brining” or “salting” refers to applying salt to cheese by adding, rubbing, or soaking.

As used herein, the term “starter culture” or “fermentation starter” refers to microbiological culture which performs fermentation.

As used herein, the term “thermophilic bacteria” refers to a bacteria that thrives in high temperatures, for example, between about 35° C. to about 52° C.

As used herein, the term “mesophilic bacteria” refers to a bacteria that thrives in moderate temperatures, for example, between about 15° C. to about 38° C.

As used herein, the term “whole plant foods” refers to foods that have not been processed, refined or had ingredients added to them. Non-limiting examples include fruits, vegetables, legumes, nuts, seeds, or whole grains.

As used herein, the term “syneresis” refers to contraction of a gel and extraction of liquid.

### Coagulated Food Product

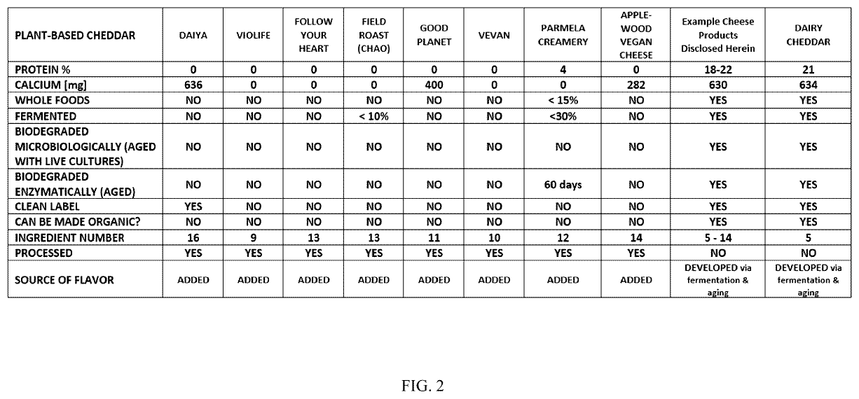

The present disclosure provides for a fermented non-dairy food product (e.g., non-dairy cheese) that is coagulated with hydrocolloid fibers that are added to a nutrient base. In general, the disclosed non-dairy food product comprises a protein content higher than alternative non-dairy food products, such as currently available non-dairy cheeses (FIG. 2), and comparable to dairy-based food products, such as dairy-based cheese.

For example, the protein content (e.g., a non-dairy protein) may be at least 12% w/w, at least 13% w/w, at least 14% w/w, at least 15% w/w, at least 16% w/w, at least 17% w/w, at least 18% w/w, at least 19% w/w, at least 20% w/w, at least 21% w/w, at least 22% w/w, at least 23% w/w, at least 24% w/w, at least 25% w/w, at least 26% w/w, at least 27% w/w, at least 28% w/w at least 29% w/w, or at least 30% w/w. In some embodiments, the protein content (e.g., a non-dairy protein) may be about 12% w/w, about 13% w/w, about 14% w/w, about 15% w/w, about 16% w/w, about 17% w/w, about 18% w/w, about 19% w/w, about 20% w/w, about 21% w/w, about 22% w/w, about 23% w/w, about 24% w/w, about 25% w/w, about 26% w/w, about 27% w/w, about 28% w/w about 29% w/w, or about 30% w/w. In some embodiments, the protein content (e.g., a non-dairy protein) may be greater than or equal to 12% w/w, greater than or equal to 15% w/w, or greater than or equal to 20% w/w.

In some embodiment, the protein content (e.g., a non-dairy protein) may be between about 12% w/w to about 15% w/w, between about 12% w/w to about 20% w/w, between about 12% w/w to about 25% w/w, between about 15% w/w to about 20% w/w, between about 15% w/w to about 25% w/w, between about 15% w/w to about 30% w/w, between about 20% w/w to about 25% w/w, between about 20% w/w to about 30% w/w, between about 20% w/w to about 35% w/w, between about 25% w/w to about 30% w/w, or between about 25% w/w to about 35% w/w.

For the purposes of the disclosed food products (e.g., non-dairy cheese), the fermented non-dairy nutrient base from which the food product is produced may be a fermented plant milk or a fermented microbial-based milk. In general, the fermented plant milk may comprise water and one or more of milled seeds, milled nuts, milled beans, milled vegetables, or milled grain. In some embodiments, the plant milk to be fermented can be selected from soybean milk, lupini bean milk, almond milk, hemp seed milk, melon seed milk, pumpkin seed milk, oat milk, pea milk, fava bean milk, chickpea milk, sunflower seed milk, edamame milk, lentil milk, pistachio milk, peanut milk, walnut milk, cashew milk, coconut milk, watermelon seed milk, and macadamia milk.

Conventionally, non-dairy milk products were not suitable for use for cheese making as they contain low protein and high carbohydrate content. Moreover, production methods for producing prior non-dairy cheeses sought to avoid syneresis. As a result, alternative non-dairy cheese products require the addition of protein concentrates or isolates, particularly after fermentation to provide protein, and even then, protein levels of such products are well below the protein levels of dairy-food products. However, this can result in undesirable tastes. In contrast, the disclosed food products and methods do not require the addition of exogenous protein before or after fermentation or aging. In other words, in some embodiments, a protein isolate, a protein concentrate, or a combination thereof is not added to the non-dairy nutrient base to increase protein content.

In contrast, the disclosed food products utilize hydrocolloid fiber to produce a structured matrix (e.g., a synergetic gel) after addition to a nutrient base (e.g., a plant milk or microbial milk). The structured matrix creates pockets of water that are slowly released by syneresis resulting in concentration of the protein from the original nutrient base and, ultimately, a high protein coagulated food product. In general, the hydrocolloid fiber is about 1.0% w/w or less of the coagulated food product (e.g., 1.0% w/w or less, 0.9% w/w or less. 0.8% w/w or less, 0.7% w/w or less, 0.6% w/w or less, 0.5% w/w or less, 0.4% w/w or less, 0.3% w/w or less, 0.2% w/w or less, or 0.1% w/w or less). In some embodiments, the hydrocolloid fiber may be about 0.7% w/w, about 0.65% w/w, about 0.6% w/w, about 0.55% w/w, about 0.5% w/w, about 0.45% w/w, about 0.4% w/w, about 0.35% w/w, about 0.3% w/w, about 0.25% w/w, about 0.2% w/w, about 0.15% w/w, or about 0.1% w/w of the coagulated food product.

The hydrocolloid fiber is not particularly limited so long as it is capable of forming a synergetic gel when added to a nutrient base. The hydrocolloid fiber may assist in holding chemically unbound water & be able to release this water gradually. Generally, suitable hydrocolloid fibers can be derived from plants or microbes. For example, the hydrocolloid fiber can be selected from a fiber extract from seaweed, a fiber extracted from an algae (e.g., macroalgae or microalgae), acacia gum, locust bean gum, guar gum, pectin, cellulose or cellulose derivative, konjac, alginate (e.g., sodium alginate), carrageenan (e.g., κ-carrageenan), agar, gellan gum, pullulan, dextran, curdlan, levan, or xanthan. In some embodiments, the hydrocolloid fiber is a fiber from an algae, and in some embodiments, the algae may be selected from Rhodophyceae algae, Phaeophyceade algae, or Chlorophyceaealgae. In some embodiments, the hydrocolloid fiber may be a fiber extract from a microorganism of a genus selected from Xanthomonas, Sphingomonas, Pseudomonas, Aureobasidium, Streptococcus, Leuconostoc, Acetobacter, Azotobacter, Pseudomonas, Alcaligenes, Bacillus, Zymomonas, Aerobacter, Acetobacter, Actinomyces, Erwinia, Rhanella, Lactobacillus, Microbacterium, and Serratia.

Dairy milk, which is generally the starting product of dairy cheese and related products, exists as an emulsion of casein micelles and butterfat droplets. The disclosed non-dairy food product may comprise emulsifiers (e.g., sunflower lecithin, soy lecithin, or lecithin granules) and emulsion stabilizers to mimic the emulsion (e.g., casein micelles and butterfat droplets) and/or support dispersion of the fat globules. In some embodiments, the emulsion stabilizers can be a plant-based oil or microbial-based oil. In some embodiments, the plant-based oil can be selected from shea butter, shea olein,, palm oil,, palm olein, palm kernel oil, pongamia oil, and any combination thereof. Additionally suitable plant oils include, but are not limited to, canola oil, soy oil, olive oil, sesame oil, corn oil, flax seed oil, and rice bran oil.

In some embodiments, the plant-or microbial-based oil may comprise a solid fat content (SFC) curve that is +/−20% of a SFC curve of anhydrous milk fat (AMF) or lard at 10° C., +/−20% of a SFC curve of AMF or lard at 15° C., +/−10% of a SFC curve of AMF or lard at 20° C., +/−10% of a SFC curve of AMF or lard at 25° C., +/−10% of a SFC curve of AMF or lard at 30° C., +/−10% of a SFC curve of AMF or lard at 35° C., and/or +/−10% of a SFC curve of AMF or lard at 40° C. In some embodiments, the plant-or microbial-based oil may comprise a SFC curve that is +/−9% of a SFC curve of AMF or lard at 10° C., +/−9% of a SFC curve of AMF or lard at 15° C., +/−9% of a SFC curve of AMF or lard at 20° C., +/−9% of a SFC curve of AMF or lard at 25° C., +/−9% of a SFC curve of AMF or lard at 30° C., +/−9% of a SFC curve of AMF or lard at 35° C., and/or +/−9% of a SFC curve of AMF or lard at 40° C. In some embodiments, the plant-or microbial-based oil may comprise a SFC curve that is +/−8% of a SFC curve of AMF or lard at 10° C., +/−8% of a SFC curve of AMF or lard at 15° C., +/−8% of a SFC curve of AMF or lard at 20° C., +/−8% of a SFC curve of AMF or lard at 25° C., +/−8% of a SFC curve of AMF or lard at 30° C., +/−8% of a SFC curve of AMF or lard at 35° C., and/or +/−8% of a SFC curve of AMF or lard at 40° C. In some embodiments, the plant-or microbial-based oil may comprise a SFC curve that is +/−7% of a SFC curve of AMF or lard at 10° C., +/−7% of a SFC curve of AMF or lard at 15° C., +/−7% of a SFC curve of AMF or lard at 20° C., +/−7% of a SFC curve of AMF or lard at 25° C., +/−7% of a SFC curve of AMF or lard at 30° C., +/−7% of a SFC curve of AMF or lard at 35° C., and/or +/−7% of a SFC curve of AMF or lard at 40° C. In some embodiments, the plant-or microbial-based oil may comprise a SFC curve that is +/−6% of a SFC curve of AMF or lard at 10° C., +/−6% of a SFC curve of AMF or lard at 15° C., +/−6% of a SFC curve of AMF or lard at 20° C., +/−6% of a SFC curve of AMF or lard at 25° C., +/−6% of a SFC curve of AMF or lard at 30° C., +/−6% of a SFC curve of AMF or lard at 35° C., and/or +/−6% of a SFC curve of AMF or lard at 40° C. In some embodiments, the plant-or microbial-based oil may comprise a SFC curve that is +/−5% of a SFC curve of AMF or lard at 10° C., +/−5% of a SFC curve of AMF or lard at 15° C., +/−5% of a SFC curve of AMF or lard at 20° C., +/−5% of a SFC curve of AMF or lard at 25° C., +/−5% of a SFC curve of AMF or lard at 30° C., +/−5% of a SFC curve of AMF or lard at 35° C., and/or +/−5% of a SFC curve of AMF or lard at 40° C. In some embodiments, the plant-or microbial-based oil may comprise a SFC curve that is +/−4% of a SFC curve of AMF or lard at 10° C., +/−4% of a SFC curve of AMF or lard at 15° C., +/−4% of a SFC curve of AMF or lard at 20° C., +/−4% of a SFC curve of AMF or lard at 25° C., +/−4% of a SFC curve of AMF or lard at 30° C., +/−4% of a SFC curve of AMF or lard at 35° C., and/or +/−4% of a SFC curve of AMF or lard at 40° C. In some embodiments, the plant-or microbial-based oil may comprise a SFC curve that is +/−3% of a SFC curve of AMF or lard at 10° C., +/−3% of a SFC curve of AMF or lard at 15° C., +/−3% of a SFC curve of AMF or lard at 20° C., +/−3% of a SFC curve of AMF or lard at 25° C., +/−3% of a SFC curve of AMF or lard at 30° C., +/−3% of a SFC curve of AMF or lard at 35° C., and/or +/−3% of a SFC curve of AMF or lard at 40° C. In some embodiments, the plant-or microbial-based oil may comprise a SFC curve that is +/−2% of a SFC curve of AMF or lard at 10° C., +/−2% of a SFC curve of AMF or lard at 15° C., +/−2% of a SFC curve of AMF or lard at 20° C., +/−2% of a SFC curve of AMF or lard at 25° C., +/−2% of a SFC curve of AMF or lard at 30° C., +/−2% of a SFC curve of AMF or lard at 35° C., and/or +/−2% of a SFC curve of AMF or lard at 40° C. In some embodiments, the plant-or microbial-based oil may comprise a SFC curve that is +/−1% of a SFC curve of AMF or lard at 10° C., +/−1% of a SFC curve of AMF or lard at 15° C., +/−1% of a SFC curve of AMF or lard at 20° C., +/−1% of a SFC curve of AMF or lard at 25° C., +/−1% of a SFC curve of AMF or lard at 30° C., +/−1% of a SFC curve of AMF or lard at 35° C., and/or +/−1% of a SFC curve of AMF or lard at 40° C. In other words, in some embodiments, the plant-or microbial-based oil may comprise a SFC curve that is +/−1-10% of a SFC curve of AMF or lard at 10° C., +/−1-10% of a SFC curve of AMF or lard at 15° C., +/−1-10% of a SFC curve of AMF or lard at 20° C., +/−1-10% of a SFC curve of AMF or lard at 25° C., +/−1-10% of a SFC curve of AMF or lard at 30° C., +/−1-10% of a SFC curve of AMF or lard at 35° C., +/−1-10% of a SFC curve of AMF or lard at 40° C., or any combination thereof.

The solid fat content of the disclosed non-dairy food products (e.g., non-dairy cheeses) may provide textural properties and flavor release similar or equivalent to dairy cheese. The oils or oil blends utilized in the disclosed non-dairy food products (e.g., non-dairy cheeses) can be selected to produce a melt profile comparable to anhydrous milk fat (AMF) or lard. The present inventors found that such a melt profile can be achieved, for example, using shea or palm fractions that have not undergone any modifications aside from a physical fractionation step. Thus, in some embodiments, the disclosed non-dairy food products (e.g., non-dairy cheeses) do not include hydrogenated oils, which are commonly utilized in other non-dairy alternatives that are currently marketed.

The specific blend of fats that are used in the disclosed non-dairy cheese may vary depending on the cheese and the desired attributes. In dairy cheese, the fat fraction constitutes roughly ⅓ of the product and plays a role on the texture, flavor, and functional properties (e.g., melting) of the cheese. Most high protein plant whole foods like seeds or nuts contain oils with low to no solid fat content, and bean lipid content is negligible However, tropical plant fats like palm, palm kernel, coconut, illipe, coco, sal and shea contain high contents of fat crystals at moderate temperatures and can be used to prepare fat blends with specific SFC (crystal melt) profiles to provide textural and sensory & melting functionality to the disclosed non-dairy food products. For example, fat blends with a olein percentage of about 40-65% (e.g., 40%, 45%, 50%, 55%, 60%, 65%) and a stearin percentage of about 35-60% (e.g., 35%, 40%, 45%, 50%, 55%, 60%) may improve viscoelastic parameters (e.g., firmness) and enhance creaminess. Fat blends with an olein percentage of about 30-40% (e.g., 30%, 35%, 40%) and a stearin percentage of about 60-70% (e.g., 60%, 65%, 70%) may reduce graininess and enhance smooth texture. And fat blends with an olein percentage of about 10-30% (e.g., 10%, 15%, 20%, 25%, 30%) and a stearin percentage of about 70-90% (e.g., 70%, 75%, 80%, 85%, 90%) may improve melting/meltability during baking or cooking. Those skilled in the art will understand how to utilize the melt curves provided in Example 11 to select a fat blend for the desired purpose.

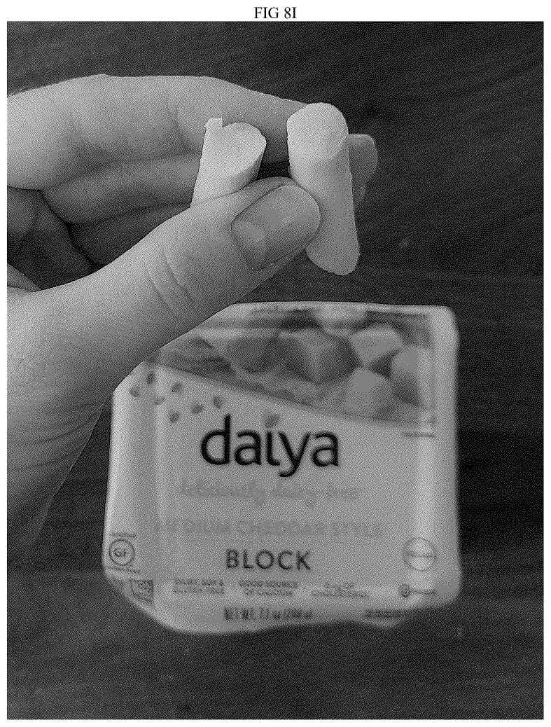

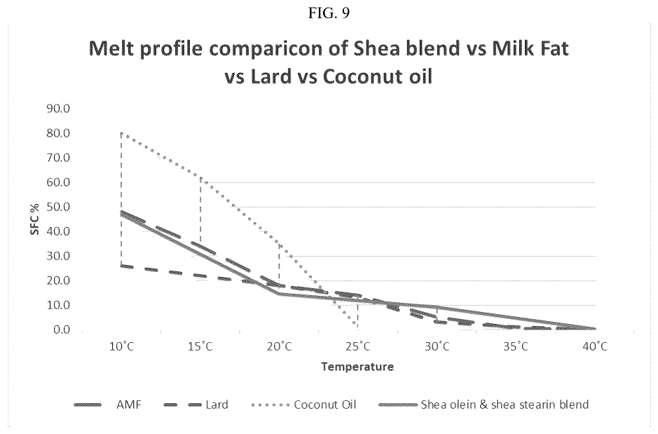

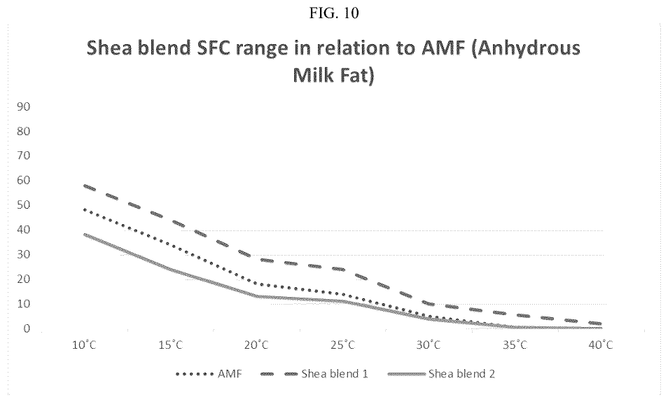

Thus, the disclosed non-dairy food products (e.g., non-dairy cheeses) may comprise a plant-or microbial-based oil that includes about 5% to about 70% (e.g., about 20% to about 40%) of a solid stearin fraction and about 30% to about 95% (e.g., about 60% to about 80%) of liquid olein fraction. For example, the plant-or microbial-based oil may comprise about 5%, about 10%, about 15%, about 20%, about 25%, about 30%, about 35%, about 40%, about 45%, about 50%, about 55%, about 60%, about 65%, or about 70% of a solid stearin fraction. In some embodiments, the plant-or microbial-based oil may comprise about 20% to about 40%, about 20% to about 35%, about 20% to about 30%, about 20%, to about 25%, about 25% to about 40%, about 25% to about 35%, about 25% to about 30%, about 30% to about 40%, about 35% to about 40% of a solid stearin fraction. Similarly, the plant- or microbial-based oil may comprise about 30%, about 35%, about 40%, about 45%, about 50%, about 55%, about 60%, about 65%, about 70%, about 75%, about 80%, about 85%, about 90%, or about 95% of a liquid olein fraction. For example, the plant-or microbial-based oil may comprise about 60% to about 75%, about 60% to about 70%, about 60% to about 65%, about 65% to about 80%, about 65% to about 75%, about 65% to about 70%, about 70% to about 80%, or about 70% to about 75% of a liquid olein fraction. Thus, the oil may comprise 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70% of a solid stearin fraction, and 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, or 95% of liquid olein fraction. In some embodiments, the fractions may be shea fractions, and in some embodiments, the fractions may be palm fractions. For example, the disclosed non-dairy food products may comprise an oil blend comprising about 20% to about 40% of a shea stearin fraction and about 60% to about 80% of shea olein fraction. In some embodiments, the disclosed non-dairy food products may comprise an oil blend comprising about 25% of a stearin shea fraction and about 75% of an olein shea fraction. This blend melts gradually improving product palatability and flavor release, as well as providing improved texture. FIGS. 9 and 10 show that plant-based oils (such as shea fraction blends) provide comparable melt profiles to milk fat and lard.

In some embodiments, the plant-based oil or the microbial-based oil is present in an amount between about 5% w/w to about 30% w/w of the coagulated food product. For example, the plant-based oil or the microbial-based oil is present in the an amount of about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, or about 30% w/w of the coagulated food product. In some embodiments, the food based oil or the microbial based oil is present in the an amount between about 5% w/w to about 10% w/w, between about 5% w/w to about 15% w/w, between about 5% w/w to about 20% w/w, between about 5% w/w to about 25% w/w, between about 10% w/w to about 15% w/w, between about 10% w/w to about 20% w/w, between about 10% w/w to about 25% w/w, between about 10% w/w to about 30% w/w, between about 15% w/w to about 20% w/w, between about 15% w/w to about 25% w/w, between about 15% w/w to about 30% w/w, between about 20% w/w to about 25% w/w, between about 20% w/w to about 30% w/w, or between about 25% w/w to about 30% w/w. In some embodiments, the plant-based oil or the microbial-based oil is present in the an amount greater than or equal to 10% w/w, greater than or equal to 12% w/w, greater than or equal to 14% w/w, greater than or equal to 16% w/w, greater than or equal to 18% w/w, greater than or equal to 20% w/w, greater than or equal to 22% w/w, greater than or equal to 24% w/w, greater than or equal to 26% w/w, greater than or equal to 28% w/w, or equal to 30% w/w.

In general, the disclosed coagulated food product (e.g., non-dairy cheese) is made from wholes plant food (and a hydrocolloid fiber, which may also be derived from a plant). In other words, the disclosed products generally do not include chemical additives. Non limiting examples of whole plant foods from which the disclosed food products may be derived include, but are not limited to, nuts, seeds, grains, beans, fruits, and vegetables. In some embodiments, the coagulated food product only comprises (i.e., consists of or consists essentially of) whole plant foods, in addition to the hydrocolloid fiber. In some embodiments, the coagulated food product consists of 10 or fewer ingredients. In some embodiments, the coagulated food product consists of 1 or more, 2 or more, 3 or more, 4 or more, 5 or more, 6or more, 7 or more, 8 or more, or 9 or more ingredients. For example, a coagulated food product (e.g., non-dairy cheese) may be made from a non-dairy nutrient base comprising about 20 to about 40% seeds, beans, or nuts, about 1% to about 5% of sauerkraut, about 1% to about 10% of miso, about 1% to about 2% of nutritional yeast, and about 43% to about 77% water.

The disclosed non-dairy cheeses are unique among non-dairy cheese alternatives because the disclosed non-dairy cheeses possess functional characteristics of dairy cheese (e.g., slice-ability, shred-ability, chewiness, meltiness, etc.) that lack in currently available dairy cheese alternatives that were on the market prior to this application. As shown in Example 7, the disclosed non-dairy cheeses possess elasticity, stiffness, and chewiness that are comparable to dairy cheese, whereas no other currently marketed non-dairy cheese alternative comes close.

In particular, the disclosed non-dairy cheeses may possess a complex modulus (G *; a measure of elasticity/stiffness) comparable to gouda cheese, i.e., a complex modulus of about 30000-50000 PA when measured at a frequency between 20-20 HZ. Similarly, the disclosed non-dairy cheeses may possess a phase angle (δ; a measure of solid/liquid balance) comparable to gouda cheese, i.e., about 8-16 when measured at a frequency between 20-20 HZ. Finally, whereas most currently marketed non-dairy cheese alternatives are not suitable for slicing or shredding or are more difficult to slice and shred, the disclosed non-dairy cheeses slice and shred similar to diary cheese, such as gouda. For example, the disclosed non-dairy cheese may have a cut force slope of less than 1.5 N/s or between 1-1.5 N/s. For the purposes of the present disclosure, any of the desirable functional features of cheese can be measured according to the method provided in Example 7.

### Methods for Producing a Fermented/Coagulated Non-Dairy Food Product

The disclosed methods are the first to use a solid-state fermentation approach to creating a non-dairy fermented food product, such as a non-dairy cheese. These methods mirror the process of making dairy cheese and therefore yield a similar, high-protein product that behaves much like dairy cheese. The disclosed methods allow for acidification and dehydration that corresponds to the acidification and dehydration that occur during the process of making dairy cheese, thus underscoring the unexpected ability of the disclosed methods to provide a non-dairy food product (e.g., a non-dairy cheese) that is exceptionally similar to dairy cheeses.

Thus, another aspect of the disclosure is directed to a method for producing a non-dairy food product (e.g., a non-dairy cheese) that generally has higher protein content (e.g., an amount of a non-dairy protein) than alternative non-dairy food products. In some embodiments, the method comprises (a) inoculating a non-dairy nutrient bases as disclosed herein, with at least one microbial culture, (b) adding at least one hydrocolloid fiber as disclosed herein to the non-dairy nutrient based inoculated with the at least one microbial culture, thereby inducing coagulation and formation of a curd; (c) removing water from the curd such that the protein content of curd is at least two times higher than the protein content of the non-dairy nutrient base.

Microbial culture can be selected from a thermophilic bacterial starter culture or a mesophilic bacterial starter culture. In some embodiment, the microbial culture is selected from lactic acid bacterium, a propionic acid bacterium, an acetic acid bacterium, or a yeast. In some embodiments, microbial culture is selected from the lactic acid bacteria genus of Lactobacillus, Leuconostoc, Pediococcus, Lactococcus, Steptococcus, Aerococcus, Corynebacterium, Oenococcus, Sporolactobacillus, Teragenococcus, Vagococcus, or Weissella, as well as acetic acid bacteria like Acetobacter and Gluconobacter and yeasts like Kluyveromyces, Pichia, and Saccharomyces. In some embodiments, the microbial culture is selected from the Lactococcus species. In some embodiments the Lactococcus species is Lactococcuss lactis. In some embodiments, the microbial culture is selected from Lactococcuss lactis subsp. cremoris, Lactococcuss lactis subsp. hordniae, Lactococcuss lactis subsp. lactis, Lactococcuss lactis subsp. tructae, or Lactococcuss lactis subsp. lactis biovar diacetylactis. In some embodiments, the microbial culture is selected from the Leuconostoc species. In some embodiments, the Leuconostoc species is Leuconostoc lactis or Leuconostoc mesenteroides. In some embodiments, the microbial culture is selected from the Streptococcus species. In some embodiments, the Streptococcus species is Streptococcus thermophilus. In some embodiments, the microbial culture is selected from Lactobacillusspecies. In some embodiments, the Lactobacillus species is selected from Lactobacillus bulgaricus, Lactobacillus lactis, or Lactobacillus helveticus. In some embodiments, the microbial culture is selected from the propionic acid bacteria genus of Propionibacterium. In some embodiments, the microbial culture is selected from the Propinibacterium species. In some embodiments, the Propinibacterium species is Propionibacterium freudenreichii. In some embodiments, the microbial culture is selected from the Propionibacterium freudenreichii subsp. shermanii. In some embodiments yeast culture is a Kluyveromyces lactis culture. In some embodiments, the microbial culture is a vegan culture. In some embodiments, the culture can be selected from cultures VEGE 022, VEGE 033, VEGE011, VEGE061, LB3, VEGETAL, CHN19, Flora Danica, L100, L200, L700, X400, C08, C21, and P100.

As disclosed herein, hydrocolloid fiber is applied to the non-dairy nutrient base to generate a synergetic gel which generally induces coagulation and formation of curd. This structured matrix creates pockets of water, and the water is slowly removed from the curd by syneresis. This process results in the protein content being at least two times higher than the protein content of the non-dairy nutrient base. In some embodiments, the protein content is at least three times higher, at least four times higher, at least five times higher, at least 6 times higher, at least 7 times higher, or at least 8 times or more higher than the protein content of the non-dairy nutrient bases.

In some embodiments, the curd after removing water has a protein content (e.g., the amount of a non-dairy protein) greater than or equal to 12% w/w, greater than or equal to 15% w/w, or great than or equal to 20% w/w. For example, the protein content may be about 12% w/w, about 13% w/w, about 14% w/w, about 15% w/w, about 16% w/w, about 17% w/w, about 18% w/w, about 19% w/w, about 20% w/w, about 21% w/w, about 22% w/w, about 23% w/w, about 24% w/w, or about 25% w/w.

The disclosed curd is aged to allow for fermentation, water loss and concentration of the constituents of the nutrient base, and flavor development, which may occur through microbial and/or enzymatic degradation of the constituents of the nutrient base. In some embodiments, the curd is aged for least then one day. In some embodiments, the curd is aged for less than one day. In some embodiments, the curd is aged between about 1 day to about 10 days. In some embodiments, the curd is aged for between about 1 day to about 2 days, between about 1 day to about 3 days, between about 1 day to about 4 days, between about 2 days to about 3 days, between about 2 days to about 4 days, between about 2 days to about 5 days, between about 3 days to about 4 days, between about 3 days to about 5 days, between about 3 days to about 6 days, between about 4 days to about 5 days, between about 4 days to about 6 days, between about 4 days to about 7 days, between about 5 days to about 6 days, between about 5 days to about 7 days, or between about 6 days to about 7 days. In some embodiments, the curd is aged for at least 1week to about 2 months. In some embodiments, the curd is aged for between about 1 week to about 2 weeks, between about 1 week to about 2 weeks, between about 1 week to about 3 weeks, between about 2 weeks to about 3 weeks, between about 2 weeks to about 4 weeks, or between about 3 weeks to about 4 weeks. In some embodiments, the curd is aged for between about 1 month to about 1.5 months, between about 1 month to about 2 months, or between about 1.5 months to about 2 months. In some embodiments, the curd is aged for between about 2 months to about 2 years. In some embodiments, the curd is aged for about 2 months to about 4 months, between about 2 months to about 6 months, between about 2 months to about 8 months, between about 4 month to about 6 months, between about 4 months to about 8 months, 4 months to about 10 months, between about 6 months to about 8 months, between about 6 months to about 10 months, between about 6 months to about 12 months, between about 8 months to about 10 months, between about 8 months to about 12 months, between about 8 months to about 14 months, between about 10 months to about 12 months, between about 10 months to about 14 months, between about 10 months to about 16 months, between about 12 months to about 14 months, between about 12 months to about 16 months, between about 12 months to about 18 months, between about 14 months to about 16 months, between about 14 months to about 18 months, between about 14 months to about 20 months, between about 16 months to about 18 months, between about 16 months to about 20 months, between about 16 months to about 22 months, between about 18 months to about 20 months, between about 18 months to about 22 months, between about 18 months to about 24 months, between about 20 months to about 22 months, between about 20 months to about 24 months, or between about 22 months to about 24 months. In some embodiments, the aging is performed in humid conditions. In some embodiments, the relative humidity is between about 20% to about 85%. In some embodiments, the relative humidity is between about 20% to about 25%, between about 20% to about 30%, between about 20% to about 35%, between about 25% to about 30%, between about 25% to about 35%, between about 25% to about 40%, between about 30% to about 35%, between about 30% to about 40%, between about 30% to about 45%, between about 35% to about 40%, between about 35% to about 45%, between about 35% to about 50%, between about 40% to about 45%, between about 40% to about 50%, between about 40% to about 55%, between about 45% to about 50%, between about 45% to about 55%, between about 45% to about 60%, between about 50% to about 55%, between about 50% to about 60%, between about 50% to about 65%, between about 55% to about 60%, between about 55% to about 65%, between about 55% to about 70%, between about 60% to about 65%, between about 60% to about 70%, between about 60% to about 75%, between about 65% to about 70%, between about 65% to about 75%, between about 65% to about 80%, between about 70% to about 75%, between about 70% to about 80%, between about 70% to about 85%, between about 75% to about 80%, between about 75% w/w to about 85%, or between about 80% to about 85% w/w.

Microperforated molds stimulate the process of syneresis releasing the water through the micro-perforations outside of the mold. This strengthens the structure and delivers a wheel, loaf, or block of non-dairy cheese than can be handled manually. Microperforated molds play a role in the enhanced protein concentration process. In some embodiments, the coagulation process is performed in a microperforated cheese mold. In some embodiments, the block, loaf, or wheel formation process is performed in a microperforated cheese mold. In some embodiments, the acidification process is performed in a microperforated cheese mold. In some embodiments, cheese is shaped or molded in a microperforated cheese mold.

In some embodiments, the curd is shaped after the water is removed and prior to aging. In some embodiments, the curd is shaped in a wheel shape or a block shape.

Brining or salting of the curd is generally used to add flavor and to act as a preservative so the non-dairy food product (e.g., non-dairy cheese) does not spoil during the aging process. These processes can be performed by adding salt directly to the curd, the outside of the non-dairy cheese product can be rubbed with salt or with a damp cloth that has been soaked in brine (e.g., heavily salted water), or the cheese can be bathed directly in a vat of brine. In some embodiments, the method for producing a non-dairy food product further comprises acidification or brining of the curd after removal of water and prior to aging the curd.

In some embodiments, the method for producing a non-dairy food product further comprises coating the curd with a water-permeable material (e.g., polymer mix) immediately prior to aging.

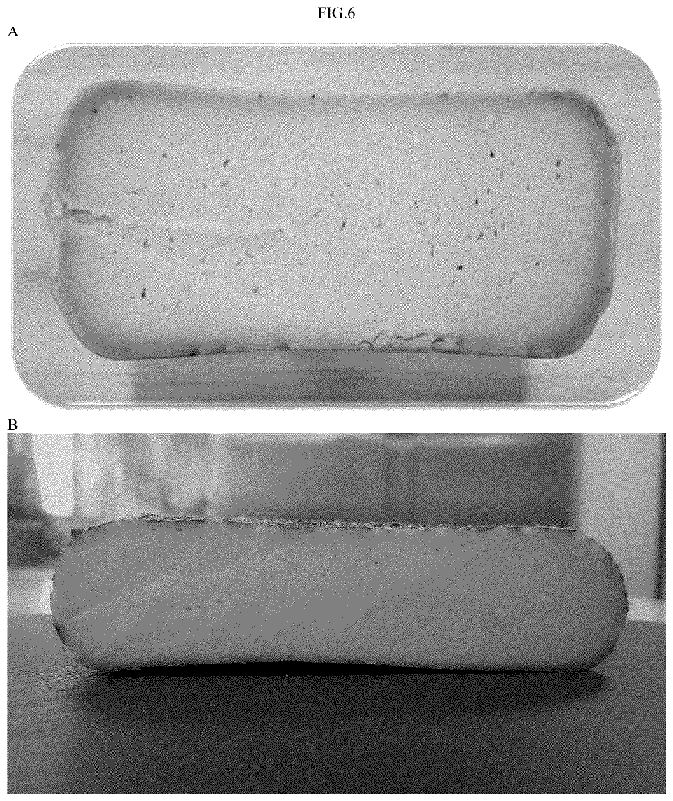

The fermentation process generally allows for natural development of flavor via fermentation from the ingredients that were used to produce the non-dairy food product. During fermentation, live microflora are formed (FIG. 6A-6B). In some embodiments, fermentation promoters or natural flavoring agents are added to the non-dairy nutrient base. In some embodiments, the fermentation promoters are selected from sauerkraut, miso, or nutritional yeast.

The present disclosure shows that fermentation using the disclosed methods can be carried out using mesophilic or thermophilic bacteria, and the resulting acidification profiles are virtually the same as dairy milk. Fermentation promoters, such as miso, sauerkraut, dextrose, and saccharolytic enzymes (e.g., hemicellulase and α-amylase) can be used to tune the acidification profile and/or correspond to a diary cheese acidification profile as shown in Example 7. Further, altering the amount of dry matter (DM) can be used to optimize the acidification profile as well. Those skilled in the art will understand how to adjust such parameters based on the Examples provided herein (e.g., Example 7).

In some embodiments, the method for producing a non-dairy food product further comprises filtering the non-dairy nutrient base (e.g., the plant milk or microbial-based milk that comprises water and either mill seeds, milled nuts, milled beans, milled grains, milled vegetables, or a combination thereof) to remove solid particles. In some embodiments, the filtering is performed before adding the hydrocolloid fiber.

In some embodiments, the non-dairy nutrient base is contacted with a protease, an amino peptidase, an amylase, a cellulase, a hemicellulose, or a combination thereof. In some embodiments, contact occurs prior to the adding the hydrocolloid fiber.

In some embodiments, the method for producing a non-dairy food product further comprises adding at least one plant-based oil or at least one microbial-based oil. In some embodiments, the plant-based oil can be selected from shea butter, shea olein, shea stearin, illipe fat, coco butter, sal butter, coconut oil, palm oil, palm kernel, pongamia oil, or any combination thereof. In some embodiments, the plant-based oil or the microbial based oil may comprise a solid fat content (SFC) curve that is +/−20% (e.g., +/−5%, 10%, 15%, or 20%) of a SFC curve of anhydrous milk fat (AMF) or lard at 10° C., +/−20% (e.g., +/−5%, 10%, 15%, or 20%) of a SFC curve of AMF or lard at 15° C., +/−10% (e.g., +/−5% or 10%) of a SFC curve of AMF or lard at 20° C., +/−10% (e.g., +/−5% or 10%) of a SFC curve of AMF or lard at 25° C., +/−10% (e.g., +/−5% or 10%) of a SFC curve of AMF or lard at 30° C., +/−10% (e.g., +/−5% or 10%) of a SFC curve of AMF or lard at 35° C., and/or +/−10% (e.g., +/−5% or 10%) of a SFC curve of AMF or lard at 40° C. (FIG. 9 and FIG. 10).

In some embodiments, the non-dairy nutrient base has a pH of 5.2 or less prior to adding the hydrocolloid fiber. In some embodiments, the pH of the non-dairy nutrient base prior to adding the hydrocolloid fiber is a pH of 5 or less, 4.5 or less, 4 or less, a pH of 3.5 or less, a pH of 3 or less, a pH of 2.5 or less, a pH of 2 or less, a pH of 1.5 or less or a pH of 1 or less.

In some embodiments, the method for producing a non-dairy food product comprises using a non-dairy nutrient base that is a plant milk, and the plant milk comprises water and either milled seeds, milled nuts, milled beans, milled grains, milled vegetables, or a combination thereof.

In some embodiments, the non-dairy nutrient base comprises at least 60% w/w of water, at least 65% w/w of water, at least 70% w/w of water, at least 75% w/w of water, or at least 80% w/w of water. In some embodiments the non-dairy nutrient base comprises between about 60% w/w to about 65% w/w of water, between about 60% w/w to about 70% w/w of water, between about 60% w/w to about 75% w/w of water, between about 65% w/w to about 70% w/w of water, between about 65% w/w to about 75% w/w of water, between about 65% w/w to about 80% w/w of water, between about 70% w/w to about 75% w/w of water, between about 70% w/w to about 80% w/w of water, or between about 75% w/w to about 80% w/w of water.

In some embodiments, the non-dairy nutrient base is selected from soybean milk, lupini bean milk, almond milk, hemp seed milk, melon seed milk, pumpkin seed milk, oat milk, pea milk, fava bean milk, chickpea milk, sunflower seed milk, edamame milk, lentil milk, pistachio milk, peanut milk, walnut milk, cashew milk, coconut milk, watermelon seed milk and macadamia milk.

In some embodiments, the hydrocolloid fiber is added to form a synergetic gel, wherein the hydrocolloid fiber, is a fiber extract. In some embodiments, the fiber extract is from seaweed, a fiber extracted from algae (e.g., macro algae or micro algae), acacia gum, locust bean gum, guar gum, pectin, cellulose or cellulose derivative, konjac, alginate (e.g., sodium alginate), carrageenan (e.g., k-carrageenan), gellan gum, agar, pullulan, dextran, curdlan, levan, or xanthan. In some embodiments the hydrocolloid fiber is a fiber from an algae and the algae may be selected from Rhodophyceae algae, Phaeophyceade algae, or Chlorophyceae algae. In some embodiments, the hydrocolloid fiber may be a fiber extract from a microorganism of a genus selected from Xanthomonas, Sphingomonas, Pseudomonas, Aureobasidium, Streptococcus, Leuconostoc, Acetobacter, Azotobacter, Pseudomonas, Alcaligenes, Bacillus, Zymomonas, Aerobacter, Acetobacter, Actinomyces, Erwinia, Rhanella, Lactobacillus, Microbacterium, and Serratia. In some embodiments, for producing a non-dairy food product does not comprise adding a protein isolate or protein concentrate to the non-dairy nutrient base (e.g., the plant-based milk or microbial-based milk), the curd, or both.

Dairy cheese is a product of fermentation that is difficult to reproduce because a solid matrix needs to be subjected to fermentation, not a liquid. The system must be designed in a way that while matrix remains solid, a sufficient amount of chemically unbound water is present for the culture to grow, dominate the environment, convert present sugars into acid at a fast rate, thus preventing growth of contaminants and preserving the food as a consequence.

The present disclosure provides novel methods of solid-state fermentation, comprising: coagulating a non-dairy nutrient base by contacting the non-dairy nutrient base with at least one hydrocolloid fiber to form a solid or gel; inoculating the non-dairy nutrient base with at least one microbial culture; and incubating the solid or gel to allow fermentation of the non-dairy nutrient base by the with at least one microbial culture in a solid-state. The disclosed methods of solid-state fermentation are distinguishable from prior methods used to prepare non-dairy foods, and specifically non-dairy cheeses. Most non-dairy cheeses that are currently on the market are not fermented at all, though a few exceptions utilize a liquid base subjected to fermentation and then processed with starch under high heat. The solid-state fermentation methods disclosed herein provide for a novel approach for preparing a fully fermented product that does not require further processing or ingredients after fermentation has completed, and which generally allows for maintaining a live culture in the product. Optionally, a fermented product (e.g., a non-dairy cheese) created by the disclosed methods may be further processed or used as an ingredient in a further food product, but such further processing in not necessary to obtain an edible, fermented food.

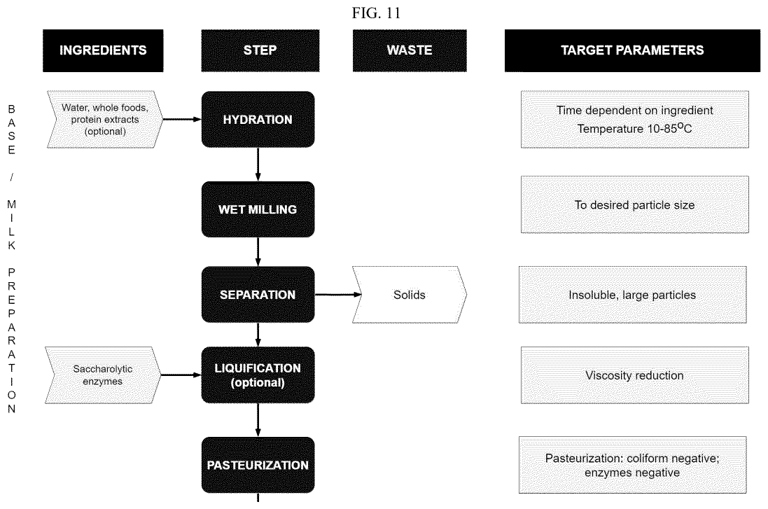

Utilizing the disclosed processes and methods it is possible to prepare a non-dairy cheese product with comparable taste, texture, elasticity, and protein content to dairy cheeses. Table 1 details examples of steps that can be used to produce a non-dairy food product (e.g. non-dairy cheese) as described herein compared to steps generally used to produce dairy cheese and further described in FIG. 12. An example of how a plant-based or microbial based milk is produced is shown in FIG. 11.

TABLE 1
A comparison between plant based or microbial
based cheese and dairy cheese production

| Plant based or Microbial | |
|---|---|
| based cheese | Dairy cheese |
| 1. Base/milk manufacturing | 1. Milk manufacturing |
| (in-house) | (farm) |
| 2. Base/milk processing & | 2. Milk processing & |
| preparation | preparation |
| 3. Inoculation | 3. Inoculation |
| 4. Coagulation (gel or curd) | 4. Coagulation (gel or curd) |
| 5. Block/wheel formation | 5. Acidification |
| 6. Acidification | 6. Block/wheel formation |
| 7. Brining | 7. Brining |
| 8. Aging | 8. Aging |

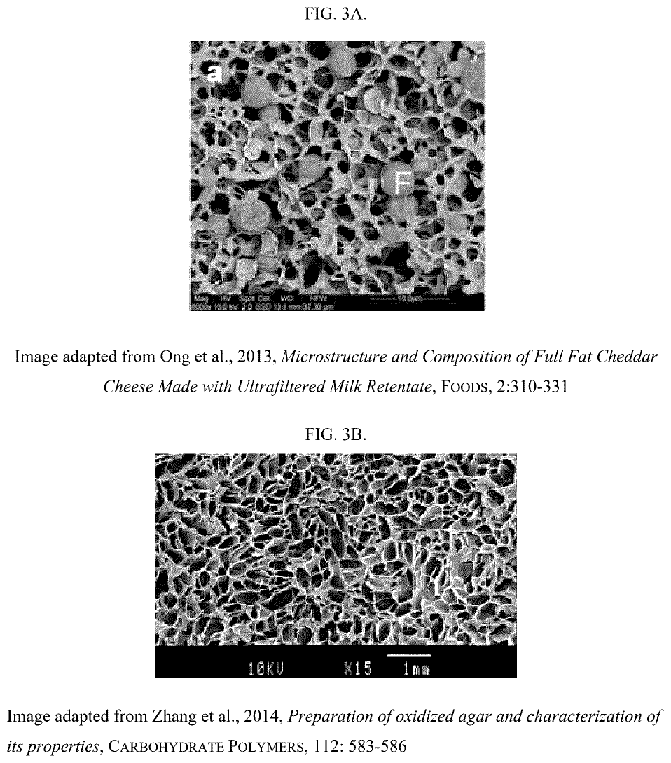

The gel or curd in step 4 of plant based or microbial based cheese is produced by hydrocolloid fiber (FIG. 3B) and the gel or curd of step 4 in dairy cheese is produced by casein. (FIG. 3A). In steps 5-8 of both processes, there is a general increase in solid content as the cheese ripens and matures and the protein content of the dairy milk or non-dairy milk is approximately 3% and the resulting protein content is generally approximately 20%.

A food product can be produced by the methods as disclosed herein. Non-limiting examples include non-dairy food products such as cheese. The disclosed food product has higher protein levels than other alternative non-dairy food products (e.g., alternative non-dairy cheeses). In some embodiments, the food product comprises only whole plant foods and a hydrocolloid fiber as ingredients. In some embodiments, the food product consists of 8 or less ingredients. In some embodiments, the food product has a protein content (e.g., an amount of a non-dairy protein) of greater than or equal to 12% w/w, greater than or equal to 14% w/w, greater than or equal to 15% w/w, greater than or equal to 16% w/w, greater than or equal to 17% w/w, or greater than or equal to 18% w/w.

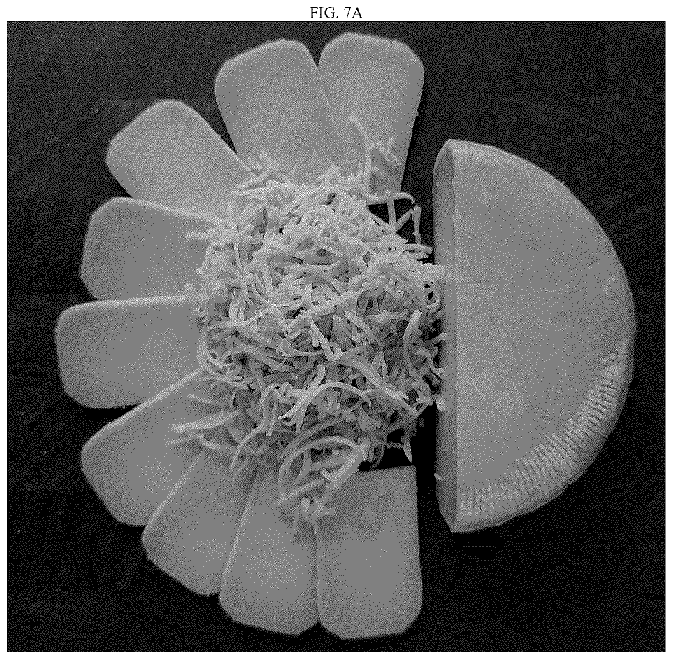

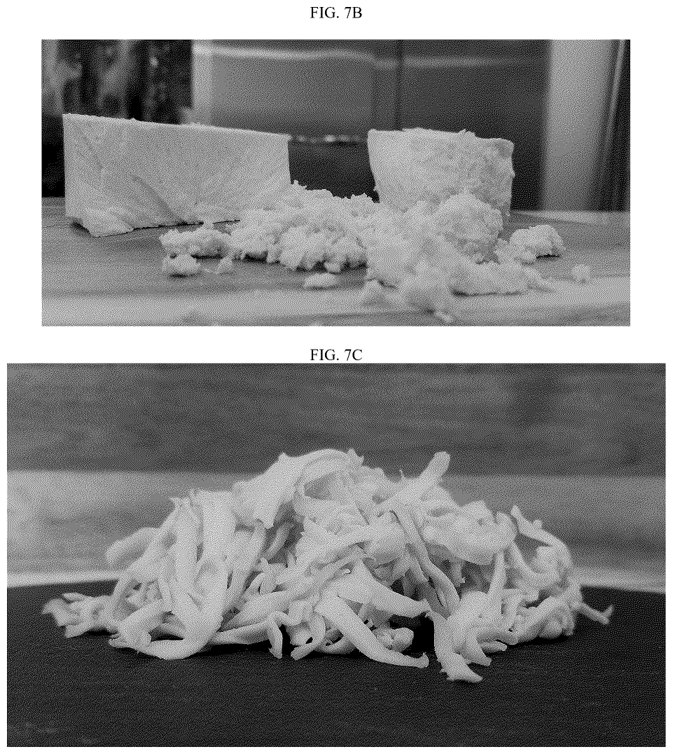

Generally, a food product as disclosed herein (e.g., non-dairy cheese) is sliceable, shred-able, and crumble-able as compared to alternative non-dairy cheeses (FIG. 7A-7C). The disclosed food product is elastic, meltable, and has enhanced sensory evaluation (e.g., taste and smell) relative to other, non-dairy cheese products. In particular, the disclosed food products possess elasticity, chewiness, meltability, sliceability, shred-ability, and springiness that is comparable to enzymatically-produced dairy cheese. In contrast, few if any other currently available non-dairy cheeses are sliceable or shred-able, and other such products lack elasticity, meltability, and springiness that is similar to dairy cheese. Instead, other such products, such as starch-based non-dairy cheeses are brittle, which is both undesirable when being consumed and results in significant loss of the product during production (e.g., during slicing or shredding) and transportation. Thus, the disclosed food products possess physically distinct and desirable characteristics that are believed to be obtained as a result of the combination or ingredients and preparation process disclosed herein. For example, without being bound by theory, it is believed that the desirable texture, melting profile, and gradual flavor release of the disclosed non-dairy cheeses may be related, at least in part, to the solid fat content of the disclosed cheeses.

The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and products within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions or biological systems, which can, of course, vary. It is also to be understood that the terminology used herein is for the purpose of describing particular embodiments only and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1% w/w-3% w/w refers to groups having 1% w/w, 2% w/w, or 3% w/w. Similarly, a group having 1% w/w-5% w/w refers to groups having 10% w/w, 20% w/w, 3% w/w, 4% w/w, or 5% w/w, and so forth.

Other aspects are set forth within the following claims.

### EXAMPLES

The present technology is further illustrated by the following Examples, which should not be construed as limiting in any way. The examples herein are provided to illustrate advantages of the present technology and to further assist a person of ordinary skill in the art with preparing or using the compositions and systems of the present technology. The examples should in no way be construed as limiting the scope of the present technology, as defined by the appended claims. The examples can include or incorporate any of the variations, aspects, or embodiments of the present technology described above. The variations, aspects, or embodiments described above may also further each include or incorporate the variations of any or all other variations, aspects or embodiments of the present technology

### Example 1: Extraction of Hydrocolloid Fiber

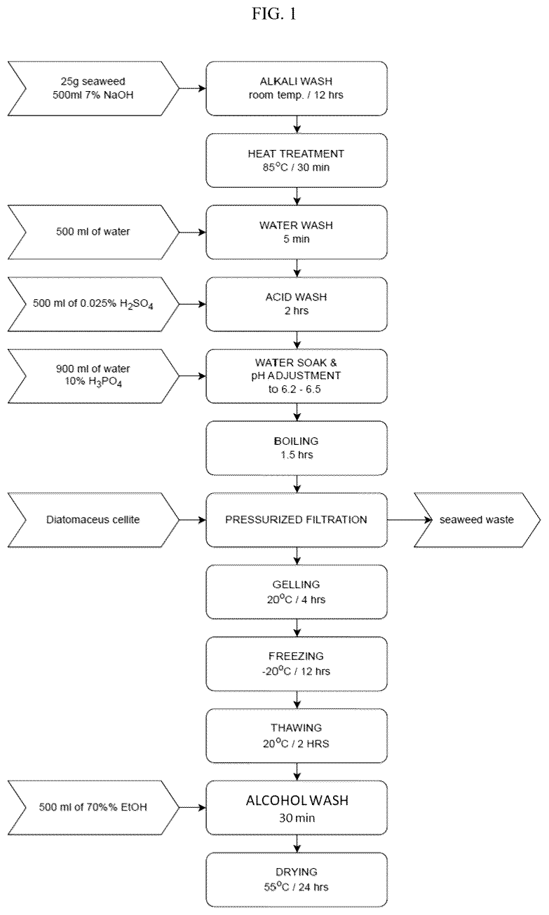

Hydrocolloid fibrous extracts were extracted from Rhodophyceae algae as shown in FIG. 1. The algae were subjected to alkali wash followed by heat treatment at 85° C. for 30 min. Then NaOH solution was washed out with water & an acid wash followed with a mild sulphuric acid (0.025%). Acid solution was replaced again by water & pH adjusted to 6.2-6.5 with 10% phosphoric acid. Such prepared solution was subjected to extraction through boiling for 1.5 hrs.

After extraction, the solution was filtered through diatomaceous earth under pressure and the fibrous extract was left to gel in a room temperature. Gel was then frozen overnight, thawed in the morning & subjected to ethanol wash. Subsequently the gel was subjected to oven drying for 24 hrs at 55° C. & milled after drying to produce a dry powder form.

### Example 2: Coagulation, Block/Wheel Formation and Acidification of the Plant-Based or Microbial Based Non-Dairy Cheese

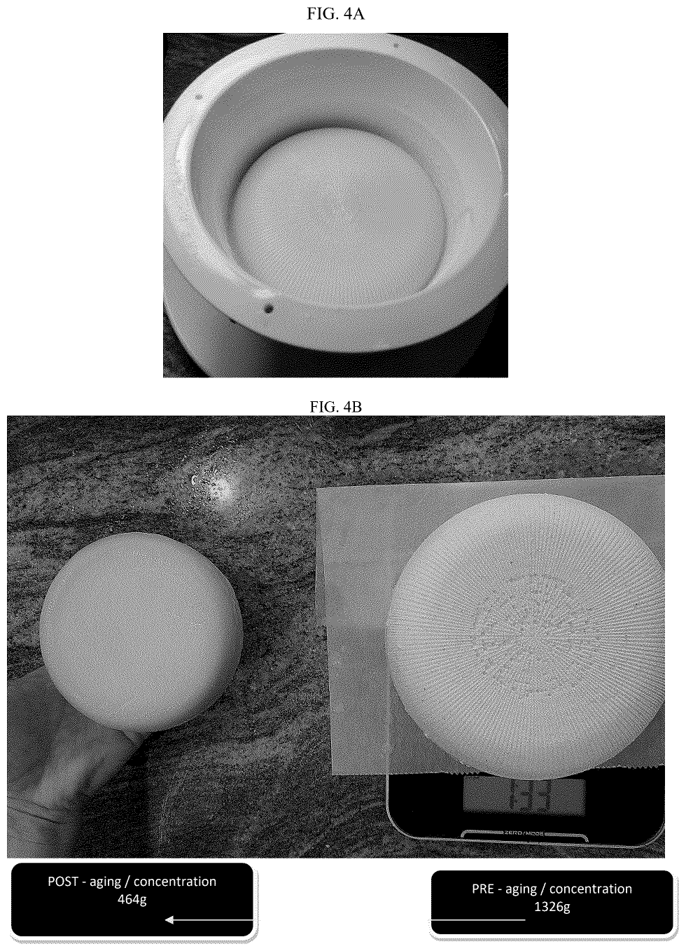

Non-dairy cheese products were coagulated in a microperforated cheese mold (FIG. 4A). During this process, syneresis occured and the cheese was pre-shrunk during acidification for approximately 6-20 hours, whereby the cheese block or wheel was formed (FIG. 4B).

### Example 3: Brining and Aging of the Plant-Based or Microbial Based Non-Dairy Cheese

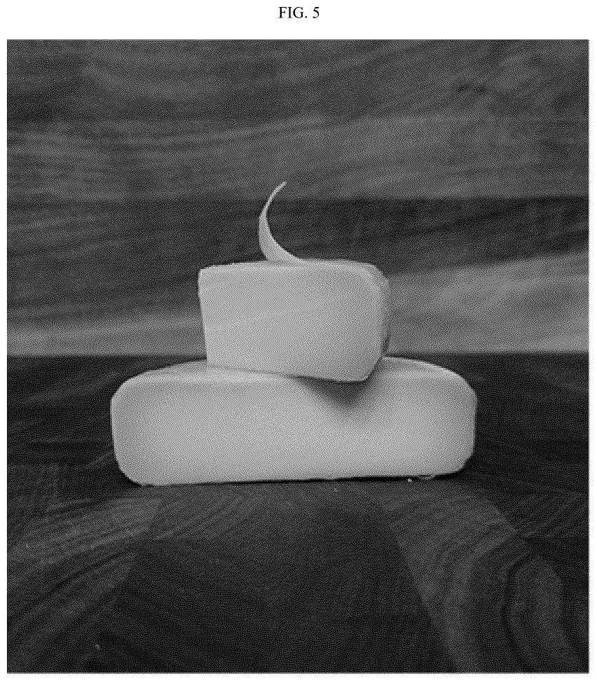

The block or wheel was sufficiently pre-shrunk to slide out of the microperforated cheese mold while holding its shape and was then brined for 3 hours in 18% NaCl solution at 55° F. The wheel was then coated with a water permeable coating and aged in the polymer for approximately 6 to 12 weeks (FIG. 4C). The wheel was flipped intermittently and recoated with the water permeable coating (FIG. 4D) until enough water was removed from the wheel or block (FIG. 5) to concentrate the components of the curd while still allowing for fermentation.

### Example 4: Enhanced Elastic Texture

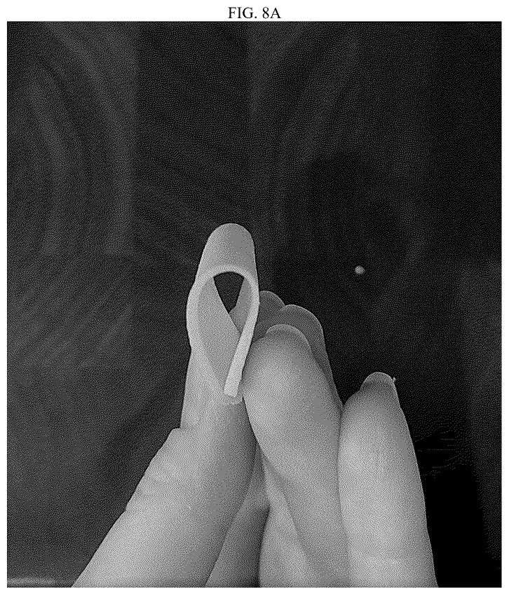

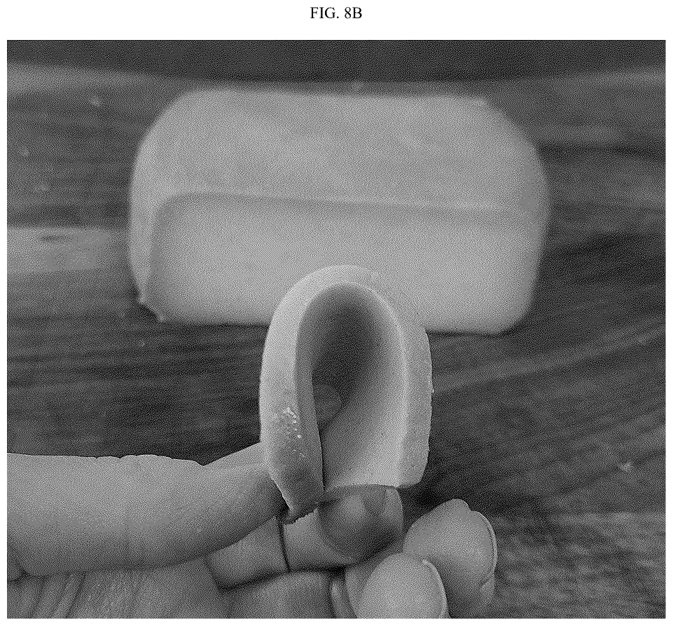

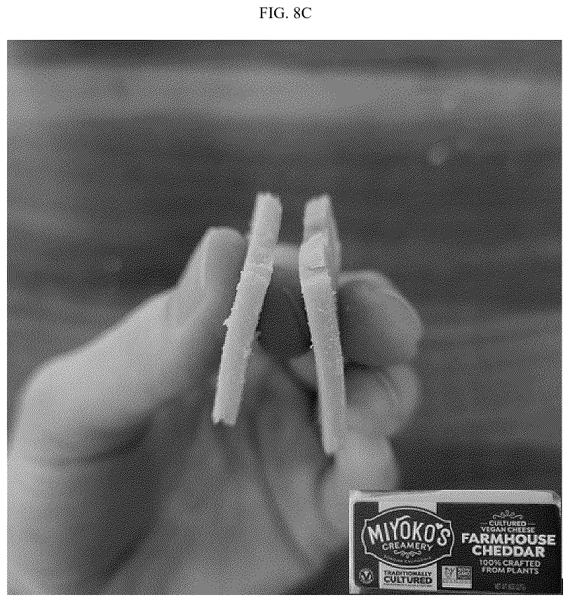

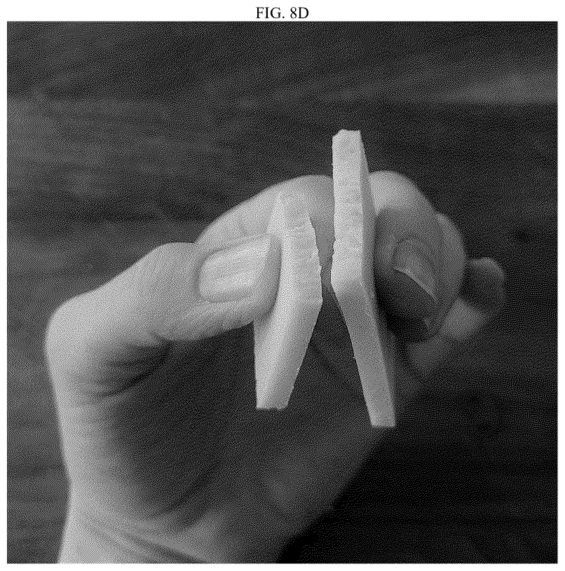

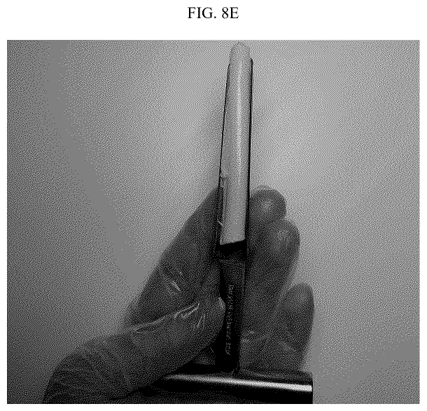

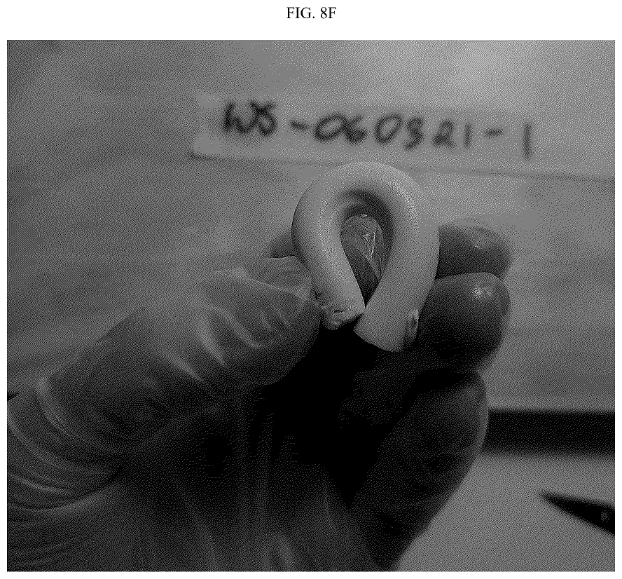

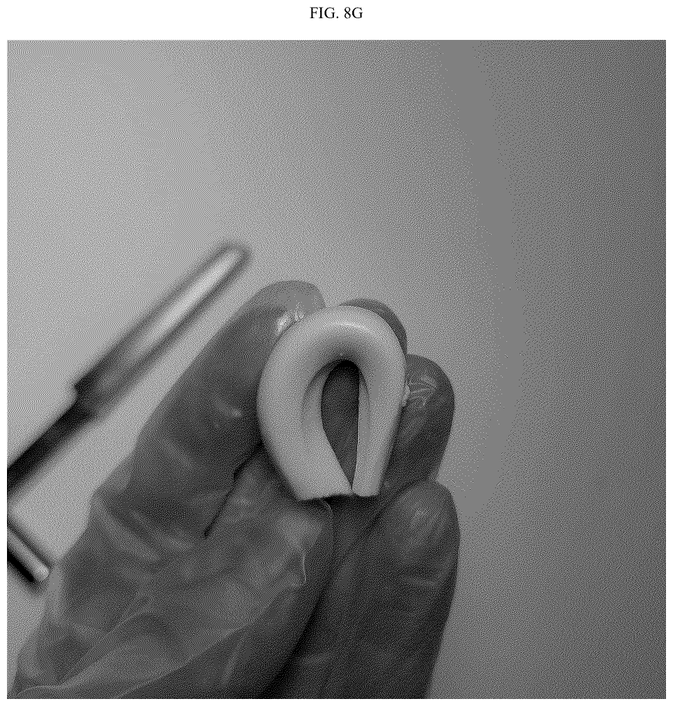

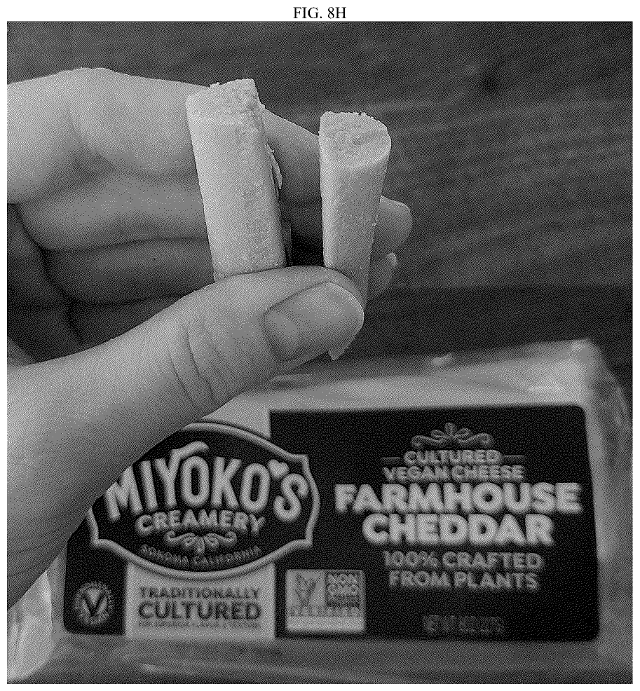

An unprocessed plant-based cheese aged for 3 months was tested for elasticity by performing consistency evaluations compared to Miyoko's Kitchen plant-based processed cheddar style cheese produced in the form of 220 g chunks and Daiya's plant-based cheddar style cheese produced in a form of 200 g chunks. Consistency of the cheese was evaluated on a sample of a sliced cheese and a plug pulled out from the cheese block or wheel by a trier (FIG. 8E). The plug was then bent in a way that the ends were meant to touch each other, and the middle part's behavior was observed. If the plug breaks in the middle the consistency is considered short & crumbly, if it stays intact, the consistency is considered long and elastic. The trier design is described in the Standard 50 b of IDF (International Dairy Federation) method of cheese sampling. The sliced sample of unprocessed plant-based cheese aged for 3 months demonstrated enhanced elastic texture (FIG. 8A-8B) as compared to Miyoko's Kitchen plant-based processed cheddar style cheese (FIG. 8C) and Daiya's plant-based cheddar style cheese (FIG. 8D). The plug of unprocessed plant-based cheese aged for 3 months demonstrated enhanced elastic texture (FIG. 8F-8G) compared to a plug from Miyoko's Kitchen plant-based processed cheddar style cheese (FIG. 8H) and Daiya's plant-based cheddar style cheese (FIG. 8I).

### Example 5: High Protein Content of Final Product >15% Comparable and Equivalent to Dairy Semi-Hard Cheese

A series of experiments were carried out during which a non-dairy milk base was prepared with hemp hearts, sour kraut, chickpea miso, nutritional yeasts and water by combining all ingredients and subjecting it to hydration for 12 hrs at 6° C. temperature in a refrigerator.

Table 2 shows examples of ingredients their respective weight used to prepare the milk base.

TABLE 2
Example non-dairy milk

| MILK | WEIGHT | WEIGHT |
|---|---|---|
| INGREDIENTS | [g] | [%] |
| Hemp hearts | 962.57 | 21.39% |
| Sour kraut | 74.87 | 1.66% |
| Chickpea miso | 118.40 | 2.63% |
| Nutritional yeast | 23.34 | 0.52% |
| Water | 3320.82 | 73.80% |
| Total weight | 4128.15 | 100% |

After hydration the whole mix was transferred to a blender (Vitamix, Explorian 310) and milled for a total time of 8 min at speed level 6.

The milled base was filtered manually using an NMO filter bag of 100 μm pore size. Filtration waste was discarded, and milk was transferred to a Thermomix (TM6) where saccharolytic enzymes (Alpha-amylase and hemicellulase, Amano) were added in amount of 0.05% each and carbohydrate liquification took place for 60 min at the temperature of 55° C.

After saccharolytic breakdown, agar-agar powder was added during agitation in the amount of 0.52%.

The milk was then pasteurized to 85° C. for 5 min and cooled to the inoculation temperature of 43° C. Once the temperature was reached, a vegan culture was added (Vege 022, DuPont) in the amount of 0.02%. At this stage, the milk had a protein content ranging between 6.56% and 7.32% of protein. Table 3 shows a composition of samples of milk bases after filtration.

TABLE 3
Sample non-dairy milk bases after filtration

| | | Fat | Moisture | DM | |
|---|---|---|---|---|---|
| Sample | Protein | (Gravi- | (Vacuum | (Calcu- | Analytical |
| description | (Dumas) | metric) | oven) | lated) | laboratory |
| Filtered | 7.32% | 12.80% | 77.39% | 22.62% | Medallion, |
| milk | | | | | MN, USA |
| Filtered | 6.56% | 11.30% | 80.74% | 19.26% | Medallion, |
| milk | | | | | MN, USA |
| Filtered | 7.16% | 11.10% | 79.23% | 20.78% | Medallion, |
| milk | | | | | MN, USA |

Table 4 shows targeted and actual process parameters used during this experiment.

TABLE 4
Examples of process parameters

| | | TARGET | ACTUAL |
|---|---|---|---|
| PROCESS | PARAMETER | PARAMETER | PARAMETER |
| Soaking | Time [hrs] | 8-12 | 12 |
| | Weight | | 1193.0 |
| | pre-soaking [g] | | |
| | Weight | | 1794.0 |
| | post-soaking [g] | | |
| Water soaked | Weight [g] | | 601.0 |
| | % | | 50% |
| Milling | Time [min] | 8 (¾ blender) | 8.0 |
| | Speed | 6 | 6.0 |
| Filtration | Yield [g] | | 3960.0 |
| | Waste [g] | | 543.4 |
| | Waste [%] | | 13.7% |
| Liquification | Time [min] | 60 | 60.0 |
| | Temp. [° F./° C.] | 131/55 | 55.0 |
| Pasteurization | Temp. [° F./° C.] | 185/85 | 85.0 |
| | Time [min] | 5 | 5.0 |
| | pH | | 6.36 |
| Inoculation | Temp. [° F./° C.] | 109/43 | 44 |
| Acidification | Time [hrs] | 16 | 17.0 |
| Fresh cheese | | | 1454.0 |
| weight [g] | | | |
| Brining | Time [hrs/min] | 2.15 | 128.7 |
| | pH after brining | | 4.83 |
| Final cheese | | | 508.0 |
| weight [g] | | | |
| % of original | | | 34.94% |
| weight | | | |

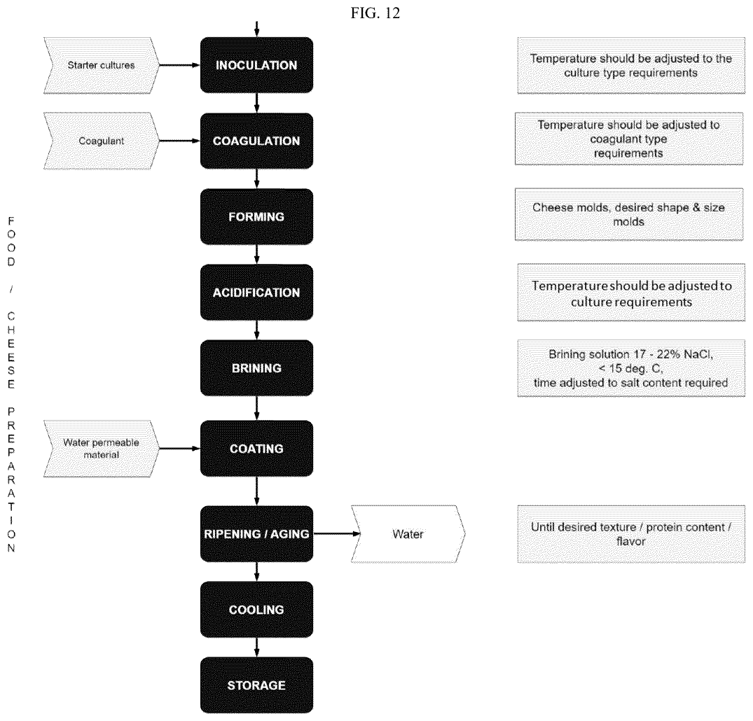

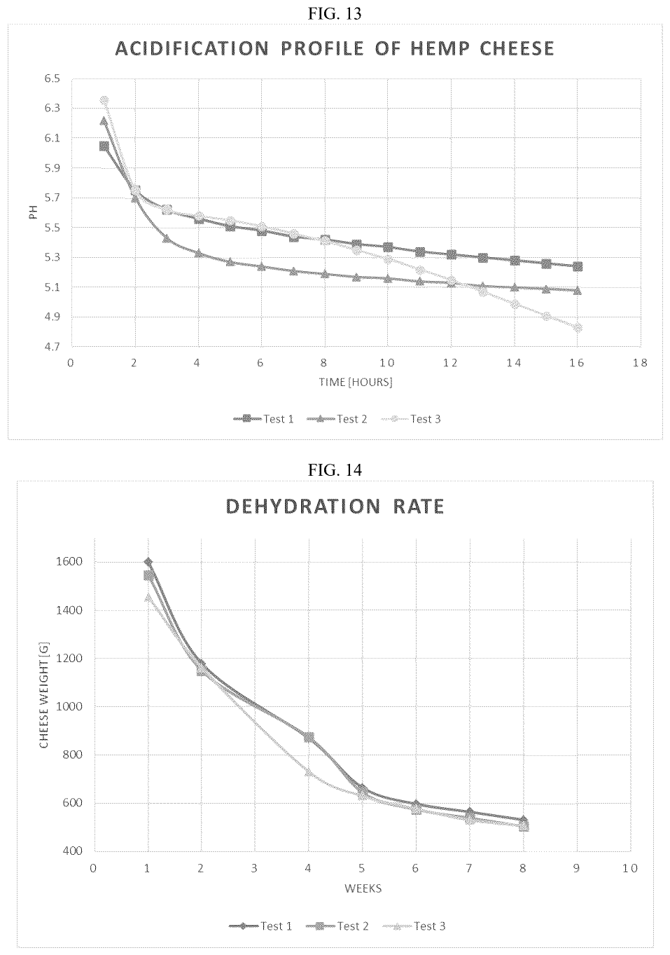

After culture addition, milk was transferred to a microperforated mold (Laude, Ø150, S110040C) and the mold was kept at 20° C. for the consequent 16 hours to allow coagulation and acidification process to take place. Monitoring of the acidification was accomplished with a pH data logger (Hanna, Edge) by inserting the probe in the center of the cheese wheel. FIG. 13 shows the acidification profile of the test cheeses.

The coagulated wheels of cheese were removed from the molds, weighed, and brined for 2 hours in 18% NaCl brine at 14° C. The brined cheese was then coated with PVA coating and placed in an incubator with RH<80% and a temperature of 13° C.

Over a period of 6 weeks the cheese was flipped periodically, and a new layer of coating was applied once a week. Cheese wheels were dehydrated this way to desired texture, after which samples of the products were collected for compositional analyses. FIG. 14 shows the dehydration rate of the test cheeses.

Aged cheese lost about 65% of weight as evaporated moisture by week 6, thus concentrating the remaining components to levels ranging from 18.4 to 20.3% protein and 35.5 to 38.9% of fat, as shown in Table 5.

TABLE 5
Contents of Test Cheeses

| | | Fat | Moisture | DM | |
|---|---|---|---|---|---|
| Test | Protein | (Gravi- | (Vacuum | (Calcu- | Analytical |
| No. | (Dumas) | metric) | oven) | lated) | laboratory |
| Test 1 | 18.40% | 33.30% | 38.92% | 61.08% | Medallion, |
| | | | | | MN, USA |
| Test 2 | 20.30% | 34.80% | 35.52% | 64.48% | Medallion, |
| | | | | | MN, USA |
| Test 3 | 19.90% | 34.4% | 36.80% | 63.20% | Medallion, |
| | | | | | MN, USA |

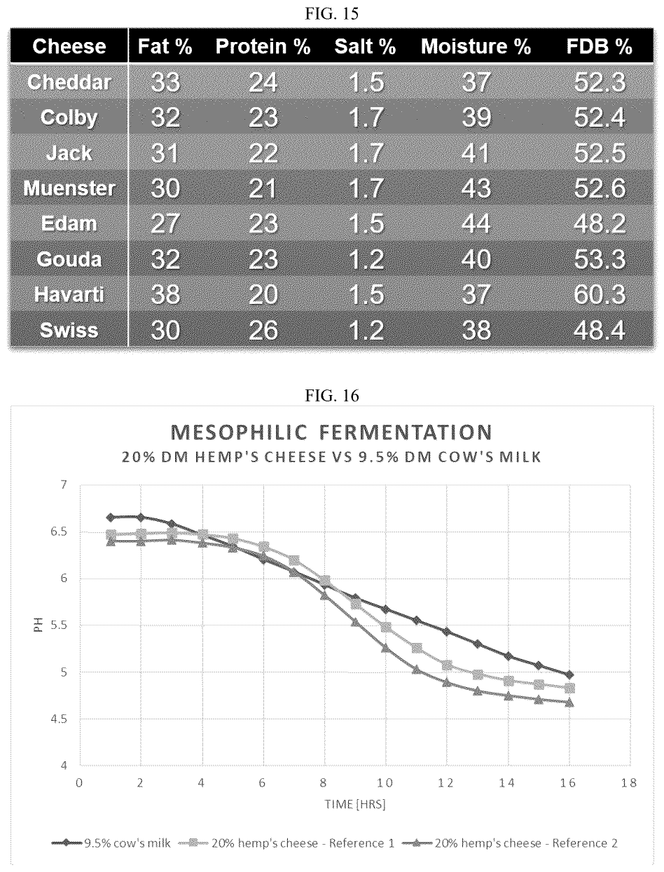

Thus, the amount of protein in each test cheese was above 15% in all three test cases, which makes the protein content comparable to the protein level of dairy cheeses (see FIG. 15). Additional tests with other non-dairy milk bases (e.g., melon seed, lupine bean, and almond) have been performed and achieved similar or greater levels of protein content.

In contrast, the protein content of currently marketed plant-based cheese products was also studied, and Table 6 shows a comparison of the currently marketed plant-based cheese products with the disclosed non-dairy cheeses.

TABLE 6
Protein Content of Examples of Select
Non-Dairy and Dairy Cheeses

| SEMI HARD CHEESE | |
|---|---|
| PRODUCT EXAMPLE | PROTEIN % |
| DAIYA CHEDDAR/GOUDA | 0.0 |
| VIOLIFE ORIGINAL FLAVOR | 0.0 |
| ALBERT HEIN (AH) PB GOUDA | 0.3 |
| BEDDA CLASSIC | 0.0 |
| FOLLOW YOUR HEART | 0.0 |
| FIELD ROAST (CHAO) | 0.0 |
| GOOD PLANET CHEDDAR | 0.0 |
| VEVAN CHEDDAR | 0.0 |
| PARMELA CREAMERY CHEDDAR | 4.0 |
| APPLE-WOOD VEGAN CHEESE | 0.0 |
| The Presently Disclosed Non-Dairy Cheeses | 16.0-23.0 |
| DAIRY GOUDA “MAASLANDER” | 22.6 |
| DAIRY CHEDDAR MEDIUM | 21.4 |
| TILAMOOK | |

Most of plant-based products, though, marketed as “cheese” showed 0% protein on their label, except of Parmela Creamery cheese products (4%) and Albert Hein's Gouda alternative 0.3%. Thus, currently available plant-based cheeses contain significantly less protein than non-dairy cheeses produced by the presently disclosed methods.

### Example 6: Fermentation of Non-Dairy Cheese with the Disclosed Solid-State Fermentation System

Fermentation quality is evaluated based on the acidification profile of the product during the manufacturing process. Scaleup potential thus requires obtaining a proof of an effective and fast fermentation that can be adopted to the variable manufacturing setups and ensures reproducible quality of the product in large scale production.

A series of experiments was carried out thus to (1) establish acceptable acidification profile with commercially available cheese starter cultures from mesophilic (CHN19, Chr Hansen) and thermophilic (Vege 022, Dupont) range; (2) establish ingredients that stimulate acidification of plant-based milks; and (3) establish process parameters with stimulatory effect on acidification of plant-based milks. A list of tested ingredients is presented Table 7 below.

TABLE 7
Examples of test ingredients

| | | Active |
|---|---|---|
| INGREDIENT | DOSAGE | ingredient/mechanism |
| Nutritional yeast | 0.5-0.7% | Vitamins & nutrients |
| | | supplementation |
| Sour kraut | 1.8-2.2% | Nutrients |
| | | supplementation & |
| | | decrease of milk pH |
| Chickpea miso | 2.4-2.8% | Nutrients & fermentable |
| | | sugar supplementation |
| Dextrose/glucose | 0.1-1.0% | Fermentable sugar |
| | | supplementation |
| Hemicellulase, | 0.01-0.1% | Fermentable sugar |
| alpha-amylase | | increase from long |
| | | chain carbohydrates |

Tested process parameters list is presented below:
A. Milk dry matter (DM);
B. Pasteurization temperature; and
C. Degree of water binding in coagulated cheese.

Milk base preparation followed the process described in Example 5. Table 8 shows the composition of the milk base prepared for this reference trial:

TABLE 8
Milk base for reference trial

| MILK | TARGET | |
|---|---|---|
| INGREDIENT | WEIGHT [g] | % |
| Soaked hemp seeds | 1392.0 | 32.1% |
| Sauer kraut | 72.2 | 1.7% |
| Chickpea miso | 114.1 | 2.6% |
| Nutritional yeast | 22.5 | 0.5% |
| Water | 2737.5 | 63.1% |
| Total weight | 4338.4 | 100.0% |

The acidification profile of all trials was recorded by inserting the probe in coagulated cheese and recording pH readings every hour. Table 9 shows recorded process parameters of the reference trial:

TABLE 9
Process parameters

| | | TARGET | ACTUAL |
|---|---|---|---|
| PROCESS | PARAMETER | PARAMETER | PARAMETER |
| Soaking | Time [hrs] | 8-12 | +/−12 |
| | Weight | | 907.0 |
| | pre-soaking [g] | | |
| | Weight | | 1392.0 |
| | post-soaking [g] | | |
| Water soaked | Weight [g] | | 485.0 |
| | % | | 53% |
| Milling | Time [min] | 8 (¾ blender) | 8 |
| | Speed | 6 | 6.0 |
| Filtration | Yield [g] | | 3590.0 |
| | Waste [g] | | 666.2 |
| | Waste [%] | | 18.6% |
| Pasteurization | Temp. [° F./° C.] | 185/85 | 85.0 |
| | Time [min] | 5 | 5.0 |
| | pH | | 6.22 |
| Inoculation | Temp. [° F./° C.] | 100/38 | 38 |
| | | CHN19 | |
| | | 109/43 | 44 |
| | | VEGE22 | |
| Acidification | Time [hrs] | — | +/−15.5 |
| | pH at 15.5 hrs | 4.8-5.2 | CHN19 |
| | | | 4.68 & 4.83 |
| | | | VEGE22 |
| | | | 4.76 & 4.83 |

The trials included: (1) fermentation with a mesophilic LD type culture (CHN19), carried out in duplicate, and a comparison of recorded data to the culture's (CHN19) acidification profile in cow's milk; (2) fermentation with a thermophilic culture Vege 022 (DuPont)), carried out in duplicate, and a comparison of recorded data to the culture's (Vege 022) acidification profile in cow's milk. Cow's milk acidification data were used for comparison as freshly coagulated prototypes were characterized by high moisture content that is more comparable to milk than to pressed dairy curd.

The mesophilic fermentation results are shown in FIG. 16. These results suggest that that acidification in a non-dairy milk base was almost identical to the acidification in cow's milk when using a mesophilic culture. This result was entirely unexpected as the prepared base had twice the amount of solids as the dairy milk, which was expected to slow the acidification. This trial showed that effective mesophilic solid fermentation can be achieved with the disclosed system.

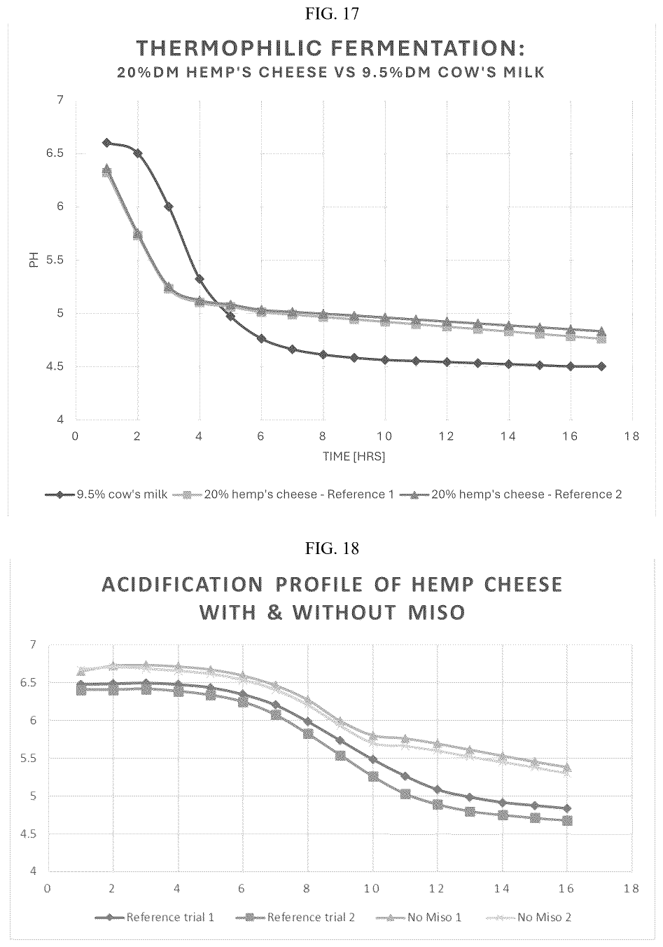

The thermophilic fermentation results are shown in FIG. 17. These results similarly suggest that acidification in a non-dairy milk base was almost identical to the acidification in cow's milk when using a thermophilic culture. The hemp milk initially acidified faster and ended with a pH that was 0.3 higher that the dairy milk dur to earlier substrate exhaustion. Nevertheless, this showed that effective thermophilic solid fermentation can be achieved with the disclosed system.

Altogether, these experiments showed that the disclosed system provides acidification profiles with non-dairy milk bases that are substantially the same or similar to acidification profiles of fermentation of dairy milk.

Further, impact on acidification of single ingredients was evaluated by subtraction of ingredients present in the reference formula or supplementation of the additional ingredients.

FIG. 18 shows the impact of miso subtraction on acidification. Miso subtraction elevated the initial pH of the milk and slowed down acidification, raising the final cheese pH value by 0.6 on average.

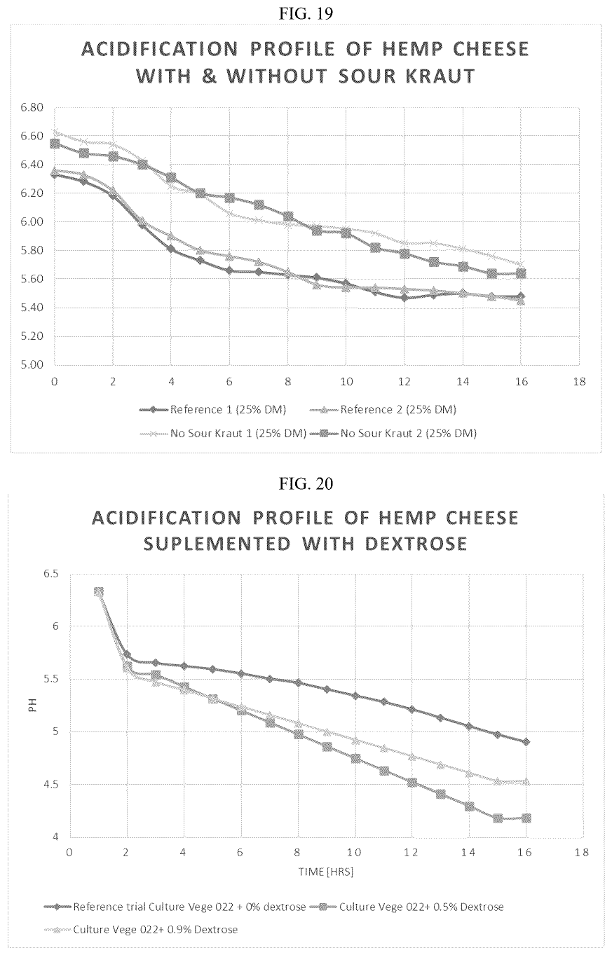

FIG. 19 shows impact of sour kraut subtraction on acidification. The impact of sour kraut subtraction was visible on 25% dry matter (DM) milk trials due to its higher concentration. The subtraction of this ingredient elevated the initial pH of the milk by 0.3 and, consequently, the final pH of the cheese by 0.3. It did not impact the acidification speed.

FIG. 20 shows the impact of dextrose supplementation on acidification. The supplementation of milk with dextrose had a significant effect on acidification speed and decreased the final cheese pH by 0.37 (0.5% dextrose) or 0.72 (0.9% dextrose).

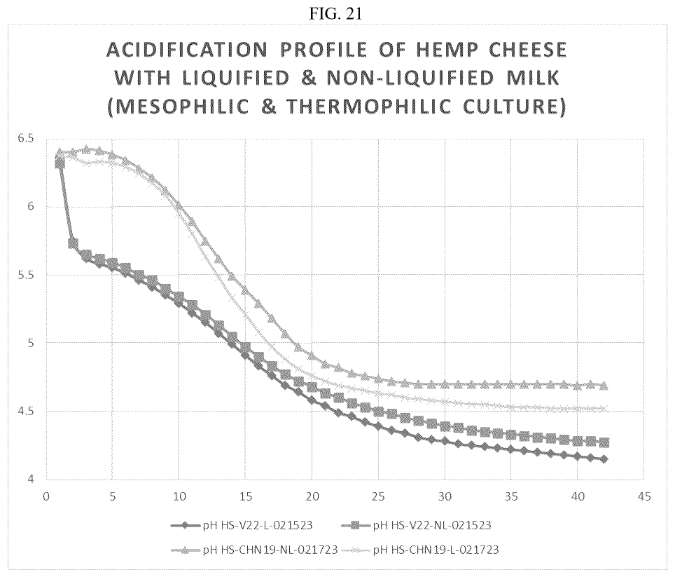

A series of 4 experiments was carried out with 2 different commercial cultures: CHN19 and Vege 022 with and without the addition of saccharolytic enzymes (hemicellulase and α-amylase). The results are presented in FIG. 21. Subtraction of saccharolytic enzymes increased the final pH of the product by 0.11 (on average) and decreased acidification speed. The impact was not drastic, and it was attributed to the low concentration of carbohydrates in hemp heart. The addition of saccharolytic enzymes can be considered a tool for optimizing acidification for plant-based milks with higher content of carbohydrates.

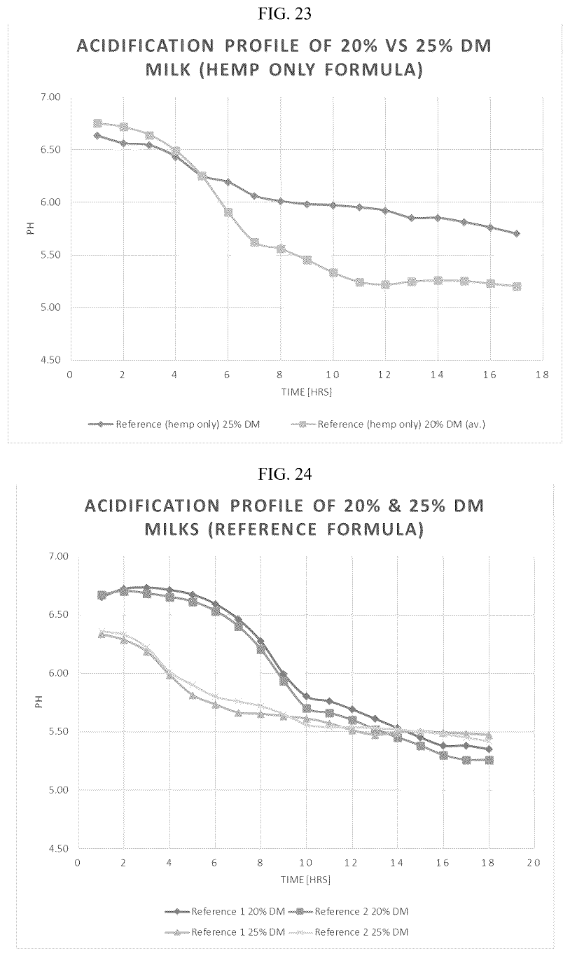

For an evaluation of the impact of milk base dry matter (DM), two sets of trials were carried out: (1) with milk base composed only from hemp hearts and water in concentrations of 20% or 25%; and (2) with milk base composed of all ingredients of the reference formula in concentrations of 20% or 25%. Cheese preparation followed the process described above. pH was also logged in the same way. FIG. 23 shows a comparison of cheese acidification profile obtained with a hemp only formula at 20% and 25% DM and FIG. 24 shows a comparison of cheese acidification profile obtained with reference formula at 20% and 25% DM.

With the hemp only milk bases, both acidification curves started from a similar level, but the acidification of 25% DM milk was slower and the final pH was 0.5 higher. It can be concluded that higher DM of the whole food itself has an inhibitory impact on acidification. With the reference formulas, acidification started at different level for 20% DM and 25% DM. The acidification of 25% DM was clearly faster at the beginning of the process, but later the 20% formula “catches up.” This is likely because the cultures used for acidification as all lactic acid bacteria belong to the group of acidophiles and grow faster in lower pH ranges.

It is useful, especially in large scale production, to obtain a rapid pH drop from the beginning of the process as this prevents development of contaminating flora. These trials show that faster acidification of higher DM milks can be achieved by adjusting their pH to a level that is more friendly to the culture.

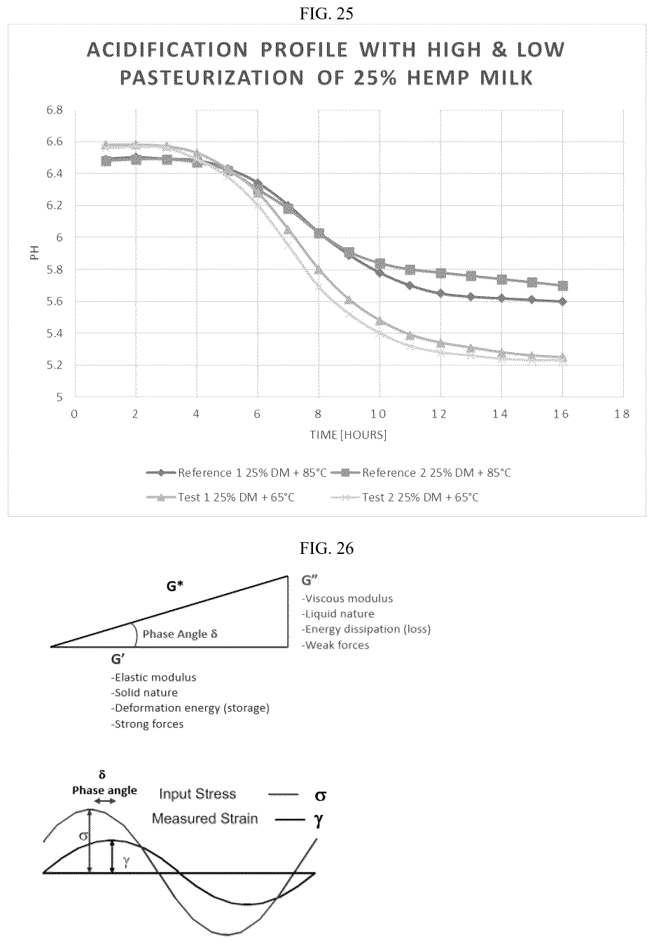

Finally, pasteurization may change the protein structure and water binding, which can have an influence of acidification profile. FIG. 25 shows CHN19 acidification profile comparison in 25% DM hemp milk pasteurized to 65° C. or 85° C. These results show that the more heat that was applied during pasteurization, the slower the acidification process and higher final pH.

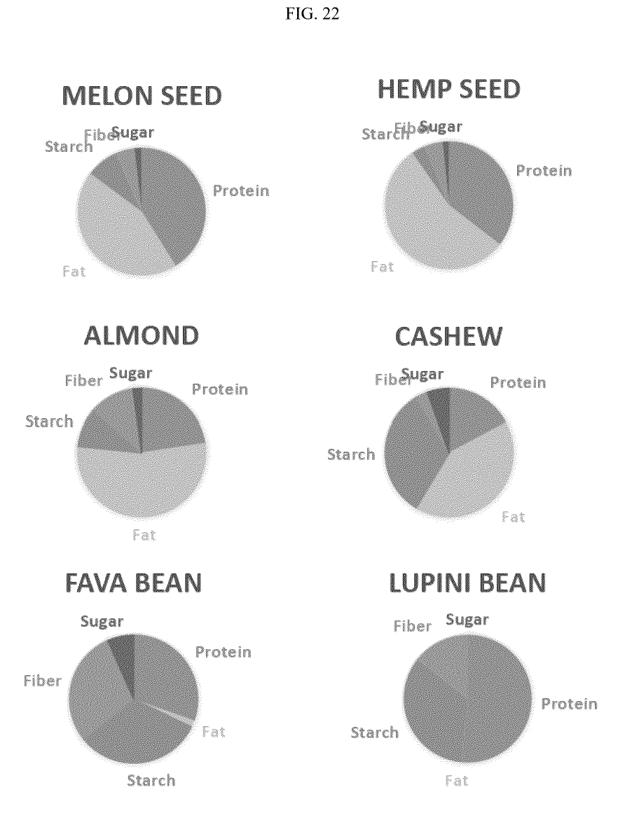

Conclusions: The disclosed solid-state fermentation system enabled a production of a fermented food product in which acidification speed and final pH can be adapted to needs defined by the manufacturing line setup or as desired for a given product. As such, the disclosed solid-state fermentation system can function with numerous types of non-dairy or plant-based milk bases (such as the components shown in FIG. 22), and the ingredients and process parameters can be adjusted as needed.

### Example 7: Elasticity, Chewiness, and Slice-Able Cheese Texture

Experiments were carried out to show that the disclosed non-dairy cheese and the disclosed technology can provide natural, semi-hard, young cheese-like texture. As a texture target, dairy young Gouda cheese was chosen and among Gouda brands, Maaslander Gouda (high fat, 50+).

Experimental design consisted of modifications of the milk base dry matter (DM) level and relative concentration of agar-agar (AA). Trials were carried out on two different whole foods at two pasteurization temperature levels. Table 10 shows tested combinations of milk dry matter and agar-agar concentrations. Tables 11 and 12 show the composition of an exemplary 20% DM hemp heart milk and an exemplary 25% DM melon kernel milk, respectively.

TABLE 10
Examples of tested agar and DM concentrations

| | | | |
|---|---|---|---|
| AA %/DM % | 20 | 22.5 | 25 |

Whole food: hemp hearts

| | | | |
|---|---|---|---|
| 0.54 | Test 0/HS | Test 4 | — |
| 0.69 | Test 1 | Test 5 | — |
| 0.74 | Test 2 | Test 6 | — |
| 0.79 | Test 3 | Test 7 | — |
| 0.74 | — | Test 8* | — |
| 0.79 | — | Test 9* | — |

Whole food: melon kernels

| | | | |
|---|---|---|---|
| 0.66 | Test 0/WS | — | Test 10 |
| 0.72 | — | — | Test 11 |
| 0.82 | — | — | Test 12 |
| 0.90 | — | — | Test 13 |

TABLE 11
Example of hemp heart-based milk

| MILK | WEIGHT | WEIGHT |
|---|---|---|
| INGREDIENTS | [g] | [%] |
| Hemp hearts | 1814.00 | 19.40% |
| Sauer kraut | 150.68 | 1.61% |
| Chickpea miso | 240.00 | 2.57% |
| Nutritional yeast | 46.97 | 0.50% |
| Water | 7100.00 | 75.92% |
| Total weight | 9351.65 | 100% |

TABLE 12
Example of melon kernel-based milk

| MILK | WEIGHT | WEIGHT |
|---|---|---|
| INGREDIENTS | [g] | [%] |
| Dry melon kernels | 2100.00 | 24.38% |
| Sour kraut | 163.82 | 1.90% |
| Chickpea miso | 220.00 | 2.55% |
| Nutritional yeast | 51.06 | 0.59% |
| Water | 6080.00 | 70.58% |
| Total weight | 8614.88 | 100% |

Preparation of milk bases followed the process described in Example 5 with modification of the pasteurization time and temperature for the Test 8 and Test 9 (which was 65° C. for 30 min).

After 6 weeks of aging, rheological properties were evaluated on rheometer Malvern Kinexus Pro and textural properties were evaluated on a TA.XTPlus C Texture Analyzer from Stable Micro Systems. The results were compared with benchmark dairy cheese (Maaslander Gouda) as well as 3 plant-based Gouda alternative cheeses obtained from the market: (1) Bedda Scheiben “Classic”, sliced and coded as Bedda PB Gouda alternative; (2) Albert Hein's “Plant-based Gouda Alternative”, sliced and coded as AH PB Gouda alternative; and (3) Daiya, “Smoked Gouda style”, block coded as Daiya PB Gouda alternative.

### Rheology

Oscillatory assays were used to determine elasticity/stiffness of the matrix G* (complex modulus) as well as the product's stress response δ (phase angle) and vertical assays were used to model chewiness.

Method: Oscillation—frequency sweep (strained controlled).

A frequency sweep generates a sample's rheological “fingerprint” associated with molecular interactions and properties across a frequency range using a % strain within the LVER (Linear Visco Elastic Region) determined by an amplitude sweep. This assay quantifies the solid/liquid nature of a sample undergoing various processes occurring over short-to long-timeframes correlating to higher through lower frequencies, respectively.

### Sample Preparation

Samples were removed from cool storage, cut to assay dimensions (described below) and allowed to warm to ambient while another sample were being assayed.

To provide consistent dimensions, samples were cut with a cylindrical cutter (25.3 mm ID). Samples were assayed with a frequency sweep from 0.1-20Hz under a 0.07% strain at 25° C. with a 25 mm rough plate. A rough surface plate was used to reduce potential for slippage at the sample-plate interface.

### Sample Loading

The cut sample discs were placed on the lower plate center, then gapped with a relatively light force of 0.2N (˜20 g; ˜weight of 8 pennies) applied to the sample to reduce the potential for water/oils displacement from the sample that would likely impact their rheological properties relative to undisturbed sample. While under compression during sample loading, the sample gap height was then set when ˜0.2 N was achieved after ˜30 seconds and the height maintained throughout the assay.

Our studies focused on 4 frequency sweep outputs, which are summarized below and shown in FIG. 26:
Complex modulus (G*) as it shows Maximum Stress σ (input)/Maximum Strain Y (response) and correlates with elasticity/stiffness of the texture. It is a balance between a solid nature (elastic modulus G′) and a liquid nature (viscous modulus G″) of the product.
Phase angle (δ) as it shows the response of a product (in terms of strain) to applied stress and correlates with the solid-liquid balance properties.
Elastic modulus (G′) as it shows the “solid nature” of a product associated with stronger forces and deformation energy (storage) within the sample. A higher G′ value correlates with increasing solid nature.
Viscous modulus (G″) as it shows the “liquid nature” associated with weaker forces and energy dissipation (loss) within the sample.

Table 13 shows Complex Modulus (G*) rank order response at 0.316 Hz under 0.07% strain at 25° C.

TABLE 13
Complex Modulus

| | RANK ORDER: |
|---|---|
| | G* Average Response |
| Sample Name | at 0.316 Hz |
| Bedda Gouda Alternative | 55,507 |
| AH Gouda Alternative | 57,977 |
| Test 0/HS | 25,815 |
| Test 8 | 25,650 |
| Test 9 | 24,685 |
| Maaslander Gouda (DAIRY) | 23,905 |
| Test 7 | 22,950 |
| Test 3 | 19,855 |
| Daiya Gouda Alternative | 15,763 |

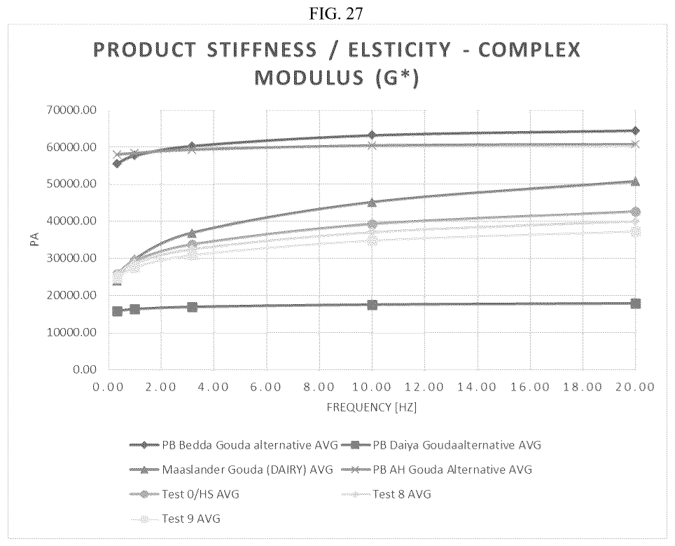

FIG. 27 shows a comparison of complex modulus (stiffness/elasticity) measurement in tested samples. The test cheeses prepared using the methods described herein possessed very similar texture elasticity/stiffness to dairy Gouda cheese, Maaslander. In contrast, other plant-based cheeses differ significantly. The test cheeses prepared using the methods described herein displayed the same type of behavior under pressure as dairy Gouda, getting stiffer with rising frequency, while other plant-based cheeses maintain similar level of stiffness regardless of applied pressure.

Table 14 shows phase angle (δ) rank order sample response to Frequency Sweep with 1 Hz under 0.07% strain at 25° C. Phase angle illustrates a balance between product's solid and liquid nature. Values 0-45° are considered more solid-like with 0° being most solid. Values 45-90° are more liquid-like with 90° being most liquid. Again, the test cheeses prepared using the methods described herein possessed very similar properties compared to dairy Gouda cheese, whereas the other plant-based alternatives did not.

TABLE 14
Phase angle

| | RANK ORDER: δ |
|---|---|
| | Average Response |
| Sample Name | at 0.316 Hz |
| Maaslander Gouda (DAIRY) | 18.4 |
| Test 4 | 10.3 |
| Test 0/HS | 10.0 |
| Test 7 | 9.1 |
| Test 8 | 8.9 |
| Bedda Gouda Alternative | 4.2 |
| Daiya Gouda Alternative | 2.8 |
| AH Gouda Alternative | 2.6 |

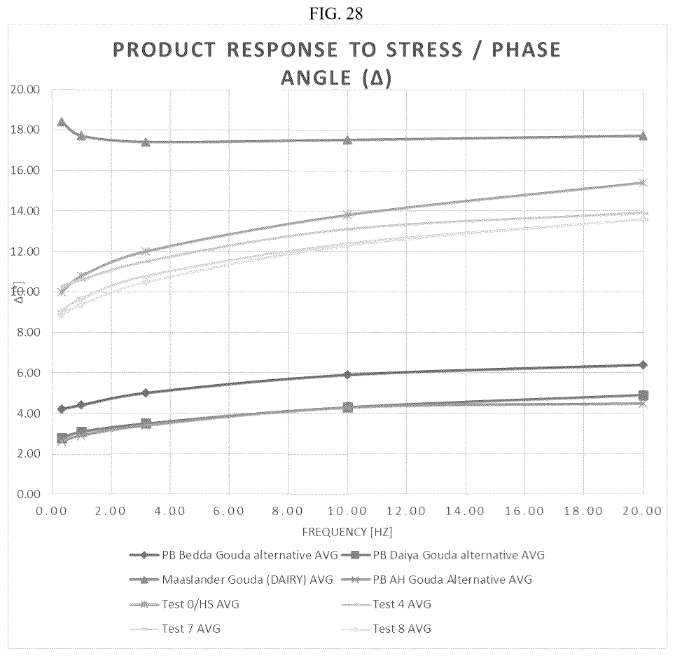

FIG. 28 shows averages of triplicate readings per sample of phase angle measurements in tested samples. Phase angle analysis (δ) for all samples scored appreciably <45° (solid dominant) and clearly defined 3 groups with very good discernment and reproducibility:
Maaslander Gouda (DAIRY)—highest δ, 18.4°
Test cheese prepared by the disclosed process—intermediate δ; 8.9-10.3°
Plant-based cheese alternatives (Bedda, Daiya and Albert Hein's Gouda alternative)—lowest δ; 4.2-2.6°.

The matrix of the chosen dairy cheese (full fat Gouda) showed high response to applied stress (18.4° at 0.314 Hz). Its response (level of strain) decreased slightly (17.7° at 20 Hz) then remained the same though the stress increase phase. Test cheese prepared by the disclosed process showed medium response to applied stress (8.9-10.3° at 0.314 Hz) and their response (strain level) increased with increased stress to a range between 13.6-15.4° at 20 Hz, bringing it close to the behavior of dairy cheese. All currently marketed plant-based cheeses showed low response to applied stress of (2.6 to 4.2° at 0.314 Hz) with a rising trend as strain increase but only to a range of 4.5-6.4° at 20 Hz displaying significant difference in their behavior.

The chewiness was determined using a vertical compression test by measurements of sample (cut disc) height change over multiple compressions (15 N) and subsequent decompression cycles (10, 3, 1, 0.3 and 0.1 N) with a 5 second hold each step.

Samples cut as discs (25 mm diameter, ˜2.0+/−0.2 mm thick) were initially loaded and thermally equilibrated to 25° C. under a relatively low stabilizing force (0.2 N; 1 N=101 g) and then compressed with 15 N with subsequent stepwise force reductions at 10, 3,1, 0.3 and 0.1 N with a 5 second hold at each step.

Negative values indicate gap (sample height) decrease under compression. Positive values indicate gap (sample height) increase under decompression. Reported sample height is last reported after 5 second hold. Table 15 summarizes test parameters.

TABLE 15
Vertical compression test parameters

| | |
|---|---|
| Sequence | Cheese Design 2023-003 25 C. Compress |
| | 15N, Decompress 15-10-3-1-0.3-0.1N |
| | 5 sec 5 cycles · rseq |
| Geometries | 40 mm smooth upper plate. Rough lower |
| | plate (Although samples were loaded as |
| | 25 mm discs, a larger plate was used to |
| | accommodate compressed sample being |
| | squeezed outside a 25 mm plate.) |
| Gap | Variable. Initially loaded with ≈0.2N |
| | applied force for temperature equilibration. |
| Sample Load | 25° C. |
| Temperature | |
| Assay Temperature | 25° C. with 4 min equilibration after |
| | consistent +/−1.0° C. target achieved |
| Compression/ | 15N (5 second hold) then stepwise |
| Decompression | decompression under 10-3-1-0.3-0.1N |
| STEP FORCES | with 5 second hold at each step. |
| Compression/ | 5 |
| Decompression | |
| CYCLES | |

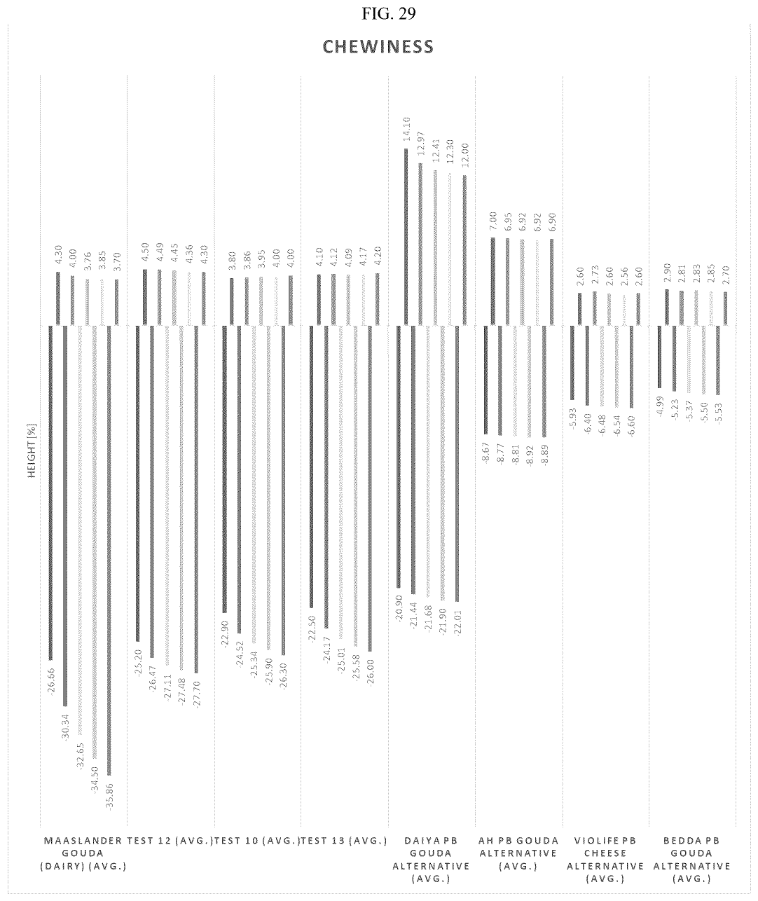

FIG. 29 shows the results of the vertical compress tests and illustrates the relative chewiness of each of the tested cheeses. Tables 16 and 17 summarize the results as well. Briefly, Maaslander, the dairy benchmark Gouda cheese, displayed the highest compressibility (−32.0%) and low compression rebound (+3.92%). The cheeses that showed closest compression match were Test 12, Test 10, Test 13 with respective compression of −26.79%, −24.99%, and −24.65%. Compressibility of the currently marketed plant-based cheese alternatives were lower, with Bedda, Violife, and AH Gouda Alternative being particularly low and significantly different from dairy Gouda. Similar, the closest match of compression rebound to dairy Gouda, Maaslander (+3.92%), also belonged to Test 10, Test 12, and Test 13 with respective values of +3.92%, +4.13% and +4.42%. The other plant based alternatives significantly differed from dairy Gouda in terms of compression rebound. Thus, the non-dairy cheeses made by the disclosed methods (i.e., Test 10, Test, 12, and Test 13) were the closest to dairy Gouda in terms of chewiness level.

TABLE 16
Compression results
COMPRESSION
(AVERAGE % height DECREASE from
initial at 0.2N to 1^{st} 15N compression)

| Group | Criteria | Samples |
|---|---|---|
| Least | 5-9 | Bedda PB Gouda alternative |
| Compressible | | (Avg. of 5 cycles −5.33%) |
| | | Violife PB cheese alternative |
| | | (Avg. of 5 cycles −6.39%) |
| | | AH PB Gouda alternative |
| | | (Avg. of 5 cycles −8.81%) |
| Medium | 24-27 | Test 10 (Avg. of 5 cycles −24.99%) |
| Compressible | | Test 13 (Avg. of 5 cycles −24.65%) |
| | | Daiya Gouda Alternative |
| | | (Avg. of 5 cycles −21.59%) |
| | | Test 12 |
| | | (Avg. of 5 cycles −26.79%) |
| High | >30 | Maaslander Gouda (dairy) |
| Compressible | | (Avg. of 5 cycles −32%) |

TABLE 17
Decompression results
DECOMPRESSION
(AVERAGE % height INCREASE from 15N to 0.2N decompression)

| Group | Criteria | Samples |
|---|---|---|
| Least | 2.6-4.5 | Violife PB cheese alternative |
| compression rebound | | (Avg. of 5 cycles +2.62%) |
| | | Bedda PB Gouda alternative |
| | | (Avg. of 5 cycles +2.82%) |
| | | Maaslander Gouda (dairy) |
| | | (Avg. of 5 cycles +3.92%) |
| | | Test 10 |
| | | (Avg. of 5 cycles +3.92%) |
| | | Test 13 |
| | | (Avg. of 5 cycles +4.13%) |
| | | Test 12 |
| | | (Avg. of 5 cycles +4.42%) |
| Medium | 6.5-7.5 | AH Gouda Alternative (6.94%) |
| compression rebound | | |
| Most | >10 | Daiya Gouda Alternative |
| compression rebound | | (12.75%) |

Extensibility, toughness, stiffness, and firmness were evaluated on TA.XT Plus C Texture Analyzer from Stable Micro Systems with a punch assay. The punch test is considered to be the most representative quantifiable assay simulating the industry recognized “texture length test” conducted on the cheese plug in ripening rooms, used by cheese makers to evaluate texture development during cheese aging/ripening. Each product sample was cut to the same dimensions of a slice form and maintained at 10° C. Table 18 shows texture analyzer settings and parameters.

TABLE 18
Punch test parameters

| Test mode | Compression | |
|---|---|---|
| Pre-test speed | 1.00 | mm/sec |
| Test speed | 1.00 | mm/sec |
| Post-test speed | 10.00 | mm/sec |
| T.A. Variable No | 5:0.0 | g |
| Target mode | Distance | |
| Distance | 15.00 | mm |
| Trigger type | Auto (Force) | |
| Trigger force | 5.0 | g |

| | |
|---|---|
| Probe | HDP/TPB |
| | BURST RIG |
| Points per second | 500 |

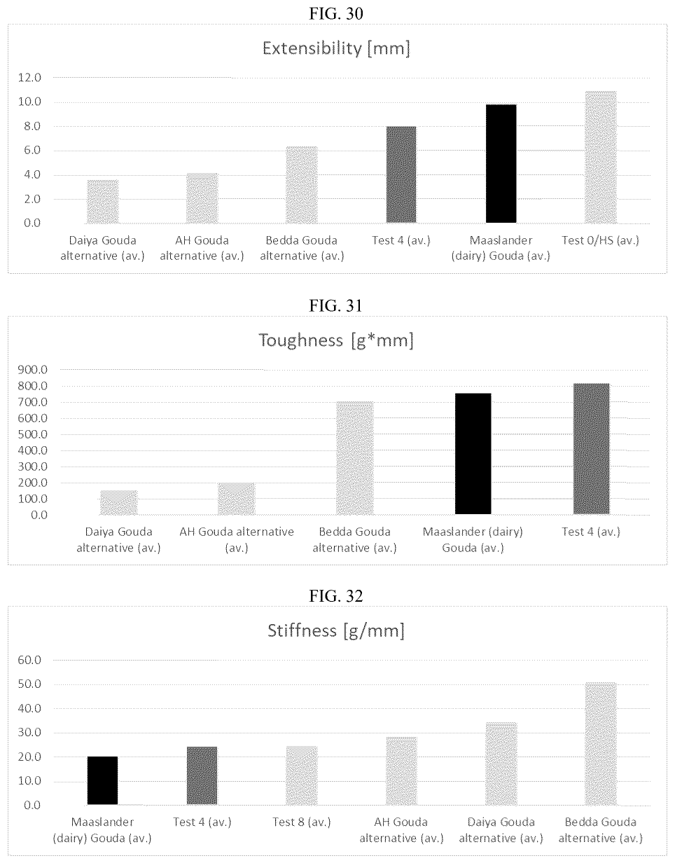

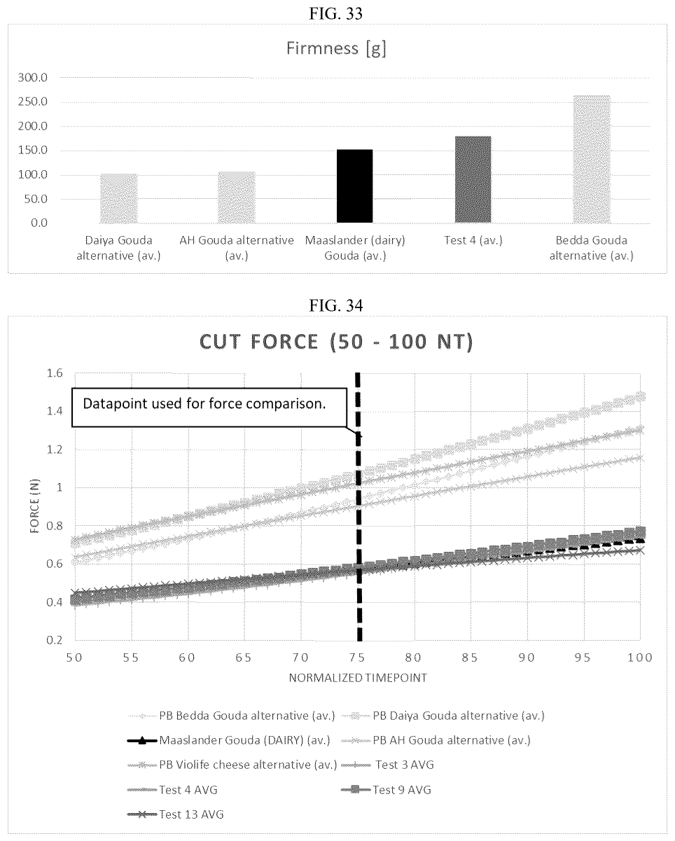

Results presented in FIGS. 30-33 show that the closest match among non-dairy cheeses to the benchmark Gouda cheese was the cheese prepared by the disclosed methods. The currently marketed plant-based cheeses that were used as a comparison all possessed significantly different extensibility, toughness, stiffness, and firmness compared to dairy Gouda.

### EXAMPLE 8: Cheese Functionality-Slicing and Shredding

The purpose of this experiment was to show that non-dairy cheese products prepared by the disclosed methods can be converted into slices and shreds like most of the dairy cheeses that are sold in high volumes and that the quality of the cutting process remains the same. Therefore, cheeses described in the foregoing examples were subjected to slicing tests using rheometer Kinexus PRO with a razor blade attachment as well as texture analyzer TA.XTPlus C from Stable Micro Systems with a cutting blade attachment. Samples were cooled to 10° C. and cut into rectangles of following dimensions: >45 mm L×15 mm W×4.0 mm H. During tests the force (N) of a blade cutting through cheese sample was measured at 1 mm/sec that allowed collecting 200 data points per test. Table 19 shows test parameters used.

TABLE 19
Parameters for cutting assessment

| | |
|---|---|
| Sequence | CUT FORCE 10 C. 1 mm per sec |
| Attachments | Rough lower plate. |
| | Razor cutter with standard 0.009″ |
| | single-sided razor blade. |
| Loading Gap (mm) | 5 |
| Sample Load | 10° C. |
| Temperature | |
| Assay Temperature | 10° C. with 4 min equilibration after |
| | consistent +/−1.0° C. target achieved |
| Maximum Force (N) | 15 |
| (1N = 101 g) | |
| Acceleration (mm/sec²) | 50.00 (linear) |
| Maximum Speed | 1 |
| (mm/sec) | |
| Deceleration (mm/sec²) | 50.00 (linear) |
| Minimum Gap (mm) | 0.3 |
| Raw Data Rate | 200 |
| (datapoints/sec) | |

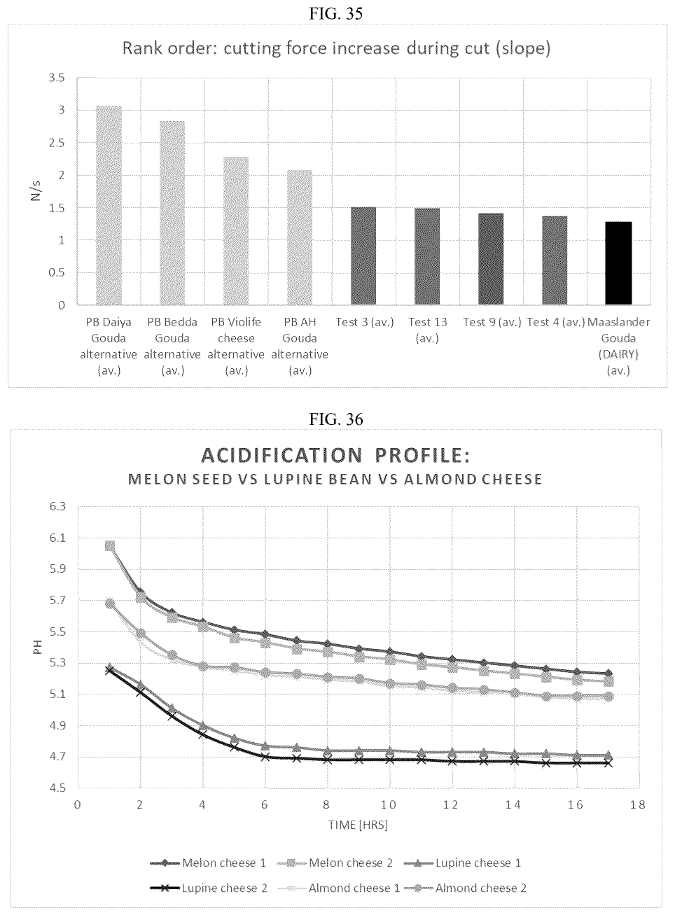

FIG. 34 shows a comparison of the cutting force needed to slice through the tested cheeses and FIG. 35 shows a rank order of the cutting force slope as applied throughout the slice. These test results showed that cheese prepared by the disclosed methods (e.g., Tests 9, 13, 4, and 3) require very similar level of cutting force (respectively 0.58 N, 0.57 H, 0.56 N, 0.55 N) to the dairy benchmark cheese (0.57 N), while the currently marketed plant-based cheeses required much higher cutting force. Additionally, it was noted that the currently marketed plant-based cheeses posed higher resistance during the cutting process, which is expressed by the rising slope of the curve.

Thus, this example shows that non-dairy cheeses not only require the same level of applied force during cutting as dairy benchmark cheese, but also their resistance throughout the cutting process remained at the similar level under 1.5 N/s for all the samples. In contrast, currently marketed plant-based cheese samples showed increasing resistance proving to be more difficult to cut and less amenable to slicing or shredding.

### Example 9: Alternative Whole Foods

As discussed throughout this application, various whole foods can be used in the preparation of a non-dairy milk base. Suitable whole food include, but are not limited to, nuts, seeds, beans, and other plants or components of plants. This example supports the versatility of the plant-based milk by showing successful preparation of cheese using alternative seeds (melon seeds), beans (lupine beans), and nuts (almond). Tables 20-22 show the composition of each of the non-dairy bases.

TABLE 20
Melon kernel example

| MILK | WEIGHT | WEIGHT |
|---|---|---|
| INGREDIENTS | [g] | [%] |
| Dry melon kernels | 1944.00 | 21.85% |
| Sour kraut | 151.65 | 1.70% |
| Chickpea miso | 225.00 | 2.53% |
| Nutritional yeast | 47.27 | 0.53% |
| Water | 6530.00 | 73.39% |
| Total weight | 8897.92 | 100% |

TABLE 21
Lupine bean example

| MILK | WEIGHT | WEIGHT |
|---|---|---|
| INGREDIENTS | [g] | [%] |
| Dry lupine bean kernels | 972.00 | 22.99% |
| Sour kraut | 75.83 | 1.79% |
| Chickpea miso | 107.00 | 2.53% |
| Nutritional yeast | 23.63 | 0.56% |
| Water | 3050.00 | 72.13% |
| Total weight | 4228.46 | 100% |

TABLE 22
Almond example

| MILK | WEIGHT | WEIGHT |
|---|---|---|
| INGREDIENTS | [g] | [%] |
| Dry almond kernels | 972.00 | 24.08% |
| Sour kraut | 75.83 | 1.88% |
| Chickpea miso | 105.00 | 2.60% |
| Nutritional yeast | 23.63 | 0.59% |
| Water | 2860.00 | 70.85% |
| Total weight | 4036.46 | 100% |

Lupine beans were deshelled, before incorporating into the respective milk bases. The rest of the preparation process corresponded to the process detailed in Example 5.

Acidification was tracked as described in previous examples, and the results are shown in FIG. 36. All alternative whole food cheeses acidified in a similar manner to hemp cheese and the acidification profiles suggest the potential for large-scale production of these fermented foods.

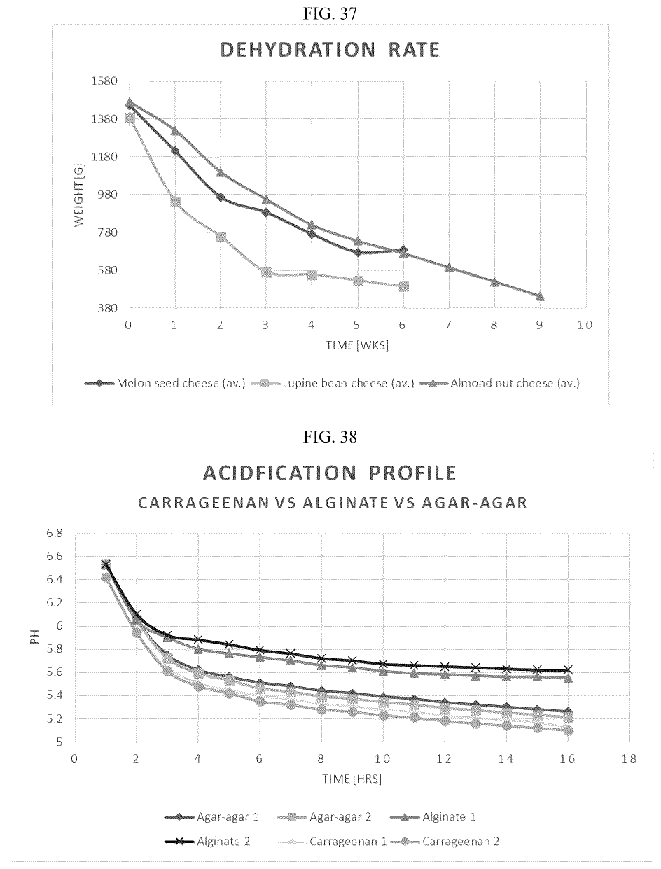

The protein content was also assessed as previously described. The protein level of the milk bases is provided in Table 23 and the protein content of the final cheese is provided in Table 24. Dehydration rates were also tracked, as shown in FIG. 37, and showed that the dehydration rates among the various tested whole food milks did not vary significantly.

TABLE 23
Content of milk bases

| | | | | Moisture | | |
|---|---|---|---|---|---|---|
| Whole | Sample | Protein | Fat | (Vacuum | DM | |
| food | description | (Dumas) | (Gravimetric) | oven) | (Calculated) | Analytical laboratory |
| Melon | Filtered | 8.53% | 15.00% | 75.16% | 24.84% | Medallion, MN, USA |
| seed | milk | | | | | |
| Lupine | Filtered | 8.22% | 5.30% | 73.60% | 26.40% | Medallion, MN, USA |
| bean | milk | | | | | |
| Almond | Filtered | 5.90% | 13.60% | 73.30% | 26.70% | Medallion, MN, USA |
| nut | milk | | | | | |

TABLE 24
Content of cheese

| | | Fat | Moisture | DM | |
|---|---|---|---|---|---|
| Whole | Protein | (Gravi- | (Vacuum | (Calcu- | Analytical |
| food | (Dumas) | metric) | oven) | lated) | laboratory |
| Melon | 19.60% | 33.70% | 36.94% | 63.06% | Medallion, |
| cheese | | | | | MN, USA |
| Lupine | 18.60% | 25.00% | 43.47% | 56.53% | Medallion, |
| cheese | | | | | MN, USA |
| Almond | 16.87% | 45.20% | 30.10% | 69.90% | Medallion, |
| cheese | | | | | MN, USA |

Aged cheeses lost, respectively, 52.45% (Melon), 64.41% and (Lupine) and 45.54% (Almond) weight by week 6, thus concentrating the protein level to 19.6% (melon), 18.60% (lupine), and 16.87% (almond, *by 9 weeks). The fat content after dehydration was 33.7% (melon), 25% (lupine), and 40.4% (almond).

In conclusion, all three alternative whole foods, the obtained level of protein was above 15% and comparable to the protein level of dairy cheese. Additionally, all cheeses obtained with alternative whole foods (lupin bean, almond nut, melon seed, and hemp seed) fermented properly and completely.

### Example 10: Alternative Coagulants

The disclosed technology can utilize various hydrocolloidal fibers. The present example provides experiments showing that k-carrageenan, sodium alginate, and agar-agar are all suitable, and underscores that other hydrocolloidal fibers would be expected to function as well.

Milk bases for this set of trials were prepared without additional ingredients such as sour kraut, nutritional yeasts, or miso. Specifically, the milk base compositions are shown in Tables 25-27.

TABLE 25
κ-carrageenan milk base composition

| MILK | WEIGHT | WEIGHT |
|---|---|---|
| INGREDIENTS | [g] | [%] |
| Dry melon kernels | 1000.00 | 26.53% |
| Sour kraut | 0.00 | 0.00% |
| Chickpea miso | 0.00 | 0.00% |
| Nutritional yeast | 0.00 | 0.00% |
| Water | 2770.00 | 73.47% |
| Total weight | 3770.00 | 100% |

TABLE 26
Sodium milk base composition

| MILK | WEIGHT | WEIGHT |
|---|---|---|
| INGREDIENTS | [g] | [%] |
| Dry melon kernels | 900.00 | 28.66% |
| Sour kraut | 0.00 | 0.00% |
| Chickpea miso | 0.00 | 0.00% |
| Nutritional yeast | 0.00 | 0.00% |
| Water | 2240.00 | 71.34% |
| Total weight | 3140.00 | 100% |

TABLE 27
Agar-agar milk base composition

| MILK | WEIGHT | WEIGHT |
|---|---|---|
| INGREDIENTS | [g] | [%] |
| Dry melon kernels | 2100.00 | 26.58% |
| Sour kraut | 0.00 | 0.00% |
| Chickpea miso | 0.00 | 0.00% |
| Nutritional yeast | 0.00 | 0.00% |
| Water | 5800.00 | 73.42% |
| Total weight | 7900.00 | 100% |

All other process steps and conditions were identical to the process described in Example 5, with slight modifications for coagulation.

FIG. 38 shows acidification profile comparison between cheese made with the differing hydrocolloidal fibers. All cheeses prepared with different coagulants acidified in a similar manner, which would be sufficient for large scale production. Additionally, all cheeses were subjected to microbiological screening, and none of the tests found any contaminant growth. This was considered additional proof that the fermentation process sufficiently preserved the food product.

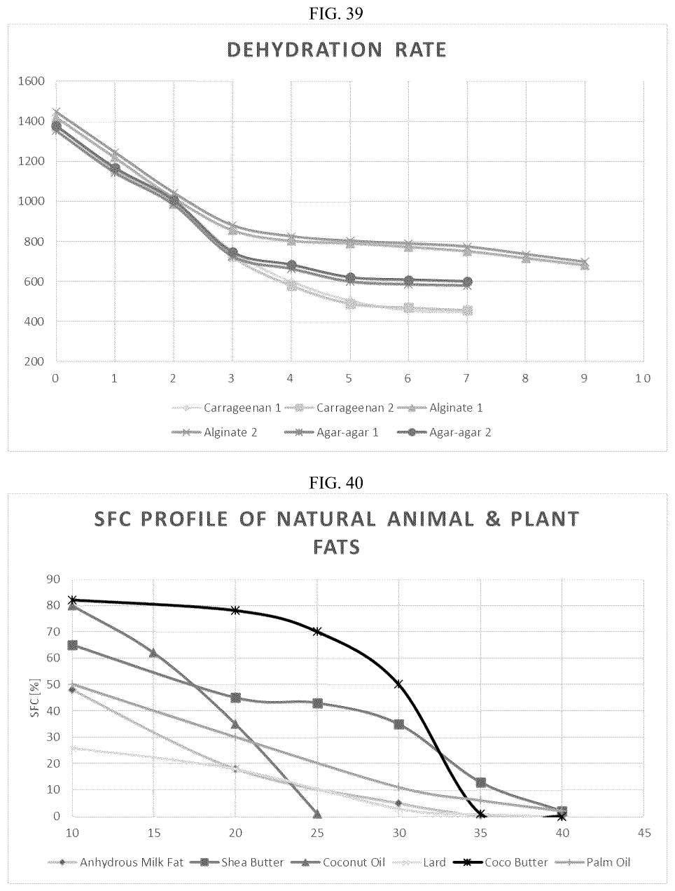

FIG. 39 shows dehydration rate of cheese coagulated with sodium alginate, κ-carrageenan, and agar-agar. Table 28 shows protein content of cheese coagulated with sodium alginate, K-carrageenan, and agar-agar. Dehydration rates and protein contents were also comparable and showed that using different coagulants still allowed for efficient solid-state fermentation and a resulting product with high protein content equivalent to dairy cheese.

TABLE 28
Protein content of cheese

| | | Fat | Moisture | DM | |
|---|---|---|---|---|---|
| | Protein | (Gravi- | (Vacuum | (Calcu- | Analytical |
| Test No. | (Dumas) | metric) | oven) | lated) | laboratory |
| Alginate | 17.8% | 32.6% | 41.579% | 58.421% | Medallion, |
| cheese | | | | | MN, USA |
| Carrageenan | 23.6% | 41.6% | 27.840% | 72.160% | Medallion, |
| cheese | | | | | MN, USA |
| Agar-agar | 21.90 | 33.00% | 36.050% | 64.950% | Medallion, |
| cheese | | | | | MN, USA |

In conclusion, all tested coagulants and other hydrocolloidal fibers can be used alternatively in described technology.

### Example 11: Fat Components of Non-Dairy Cheese

Without being bound by theory, the inventors believed that a fat blend with slightly higher SFC content above the body temperature (1-2%) may prevent the perception of graininess that often characterizes high protein plant products due to the hydrophobic nature of plant proteins. FIG. 40 shows the standard SFC content profiles of natural animal and plant fats.

In order to find appropriate fat SFC profile, a series of fat blends were prepared with a wide array of SFC profiles in temperature range between 10° C. and 45° C. Blends were prepared from fractionated shea butter in 2 fractions: shea olein (liquid fraction) and shea stearin (solid fraction) and combined in the ratios shown in Table 29.

TABLE 29
Fat blend fractions

| Name | Olein % | Stearin % |
|---|---|---|
| Fat Blend 1 | 90% | 10% |
| Fat Blend 2 | 80% | 20% |
| Fat Blend 3 | 70% | 30% |
| Fat Blend 4 | 65% | 35% |
| Fat Blend 5 | 60% | 40% |
| Fat Blend 6 | 50% | 50% |
| Fat Blend 7 | 40% | 60% |
| Fat Blend 8 | 30% | 70% |
| Fat Blend 9 | 20% | 80% |
| Fat Blend 10 | 10% | 90% |

Fractions of shea olein (Bassao E) and shea stearin (Illexao) were obtained from oils and fats manufacturer, AAK. Both fractions were fully melted with a heat blanket, combined in the above ratios, and subjected to fast crystallization in the freezer. Then samples were taken and subjected to NMR analysis. Table 30 shows the SFC profiles of the prepared fat blends.

TABLE 30
SFC profiles of fat blends

| BLEND NAME | SFC 10° C. | SFC 20° C. | SFC 30° C. | SFC 35° C. | SFC 40° C. | SFC 45° C. |
|---|---|---|---|---|---|---|
| Fat Blend 1 | 1.50% | 0.30% | 0.20% | 0.20% | 0.00% | 0.00% |
| Fat Blend 2 | 20.50% | 0.80% | 0.20% | 0.20% | 0.00% | 0.00% |
| Fat Blend 3 | 36.10% | 4.80% | 0.40% | 0.00% | 0.00% | 0.00% |
| Fat Blend 4 | 41.05% | 16.65% | 0.95% | 0.20% | 0.00% | 0.00% |
| Fat Blend 5 | 46.00% | 28.50% | 1.50% | 0.40% | 0.00% | 0.00% |
| Fat Blend 6 | 57.00% | 39.50% | 3.70% | 1.10% | 0.00% | 0.00% |
| Fat Blend 7 | 65.60% | 49.30% | 9.90% | 1.80% | 0.10% | 0.00% |
| Fat Blend 8 | 72.60% | 58.20% | 20.20% | 2.40% | 0.40% | 0.00% |
| Fat Blend 9 | 79.30% | 65.00% | 31.50% | 3.00% | 0.70% | 0.00% |
| Fat Blend 10 | 85.30% | 73.30% | 43.40% | 4.00% | 1.50% | 0.00% |
| Anhydrous milk | 48.00% | 18.00% | 5.00% | 0.50% | 0.00% | 0.00% |
| fat | | | | | | |

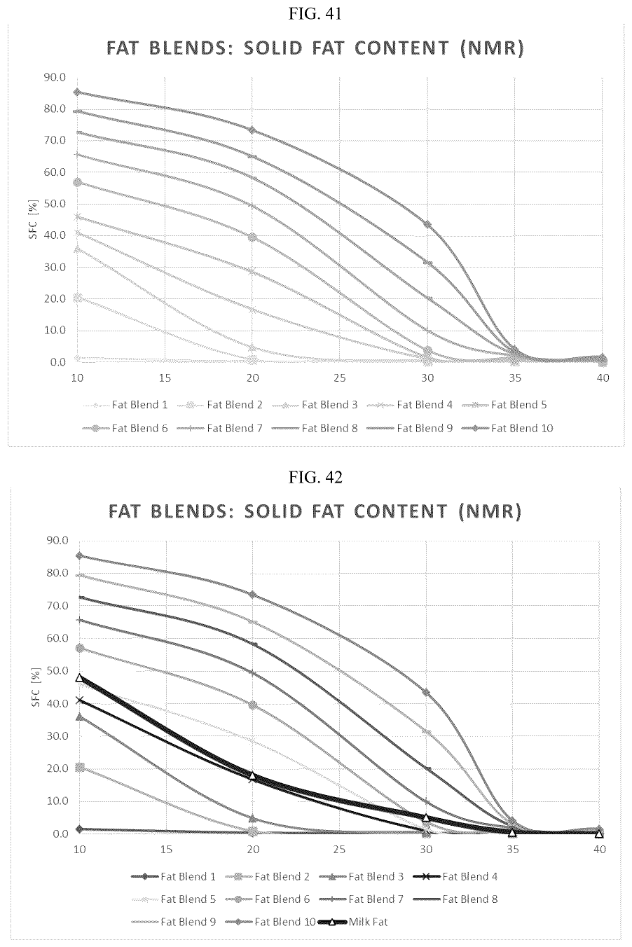

FIG. 41 shows the SFC profiles of fat blends prepared for the needs of defining appropriate fat blend characteristics. FIG. 42 shows the SFC profiles of fat blends in comparison to AMF (anhydrous milk fat). Table 31 shows the delta between AMF (anhydrous milk fat) and the blends at respective temperature points.

TABLE 31

| BLEND NAME | SFC 10° C. | SFC 20° C. | SFC 30° C. | SFC 35° C. | SFC 40° C. | SFC 45° C. |
|---|---|---|---|---|---|---|
| Fat Blend 1 | −47% | −18% | −5% | 0% | 0% | 0% |
| Fat Blend 2 | −28% | −17% | −5% | 0% | 0% | 0% |
| Fat Blend 3 | −12% | −13% | −5% | −1% | 0% | 0% |
| Fat Blend 4 | −7% | −1% | −4% | 0% | 0% | 0% |
| Fat Blend 5 | −2% | 11% | −4% | 0% | 0% | 0% |
| Fat Blend 6 | 9% | 22% | −1% | 1% | 0% | 0% |
| Fat Blend 7 | 18% | 31% | 5% | 1% | 0% | 0% |
| Fat Blend 8 | 25% | 40% | 15% | 2% | 0% | 0% |
| Fat Blend 9 | 31% | 47% | 27% | 3% | 1% | 0% |
| Fat Blend 10 | 37% | 55% | 38% | 4% | 2% | 0% |
| Anhydrous milk | 0% | 0% | 0% | 0% | 0% | 0% |
| fat | | | | | | |

Based on these results, fat blends 4, 5, and 6 may improve the viscoelastic properties, including firmness and stress response, of the disclosed non-dairy cheeses. These fat blends may also enhance creaminess. Fat blends 7 and 8 may additionally reduce textural graininess. Fat blends 7, 8, 9 and 10 may improve meltability of the cheese during baking.

1. A food product, comprising a hydrocolloid fiber and a coagulated and fermented non-dairy nutrient base that is coagulated with the hydrocolloid fiber, wherein the food product comprises a non-dairy protein in an amount greater than or equal to 15% by weight based on total weight of the food product (% w/w).

2. The food product of claim 1, wherein the non-dairy nutrient base further comprises at least one plant-or microbial-based oil.

3. The food product of claim 2, wherein the at least one plant-or microbial-based oil comprises a solid fat content (SFC) curve that is +/−20% of a SFC curve of anhydrous milk fat (AMF) or lard at 10° C., +/−20% of a SFC curve of AMF or lard at 15° C., +/−10% of a SFC curve of AMF or lard at 20° C., +/−10% of a SFC curve of AMF or lard at 25° C., +/−10% of a SFC curve of AMF or lard at 30° C., +/−10% of a SFC curve of AMF or lard at 35° C., and/or +/−10% of a SFC curve of AMF or lard at 40° C.

4. A food product, comprising a hydrocolloid fiber, a coagulated and fermented non-dairy nutrient base that is coagulated with the hydrocolloid fiber, and at least one plant-or microbial-based oil, wherein the at least one plant-or microbial-based oil comprises a solid fat content (SFC) curve that is +/−60% of a SFC curve of anhydrous milk fat (AMF) or lard at 10° C., +/−60% of a SFC curve of AMF or lard at 15° C., +/−60% of a SFC curve of AMF or lard at 20° C., +/−50% of a SFC curve of AMF or lard at 25° C., +/−50% of a SFC curve of AMF or lard at 30° C., +/−20% of a SFC curve of AMF or lard at 35° C., +/−10% of a SFC curve of AMF or lard at 40° C., or any combination thereof, or, optionally, wherein the SFC curve is +/−10% of a SFC curve of anhydrous milk fat (AMF) or lard at 10° C., +/−10% of a SFC curve of AMF or lard at 15° C., +/−10% of a SFC curve of AMF or lard at 20° C., +/−10% of a SFC curve of AMF or lard at 25° C., +/−10% of a SFC curve of AMF or lard at 30° C., +/−10% of a SFC curve of AMF or lard at 35° C., +/−10% of a SFC curve of AMF or lard at 40° C., or any combination thereof.

5. The food product of claim 4, wherein the food product comprises a non-dairy protein in an amount greater than or equal to 15% w/w.

6. The food product of claim 2, wherein the at least one plant-or microbial-based oil is selected from illipe fat, coco butter, sal butter, shea butter, shea olein, shea stearin, coconut oil, coconut stearin, palm oil, palm stearin, palm olein, palm kernel, pongamia oil, and any combination thereof.

7. The food product of claim 2, wherein the at least one plant-or microbial-based oil comprises about 5% to about 70% of a stearin shea fraction and about 30% to about 95% of an olein shea fraction.

8. The food product of claim 2, wherein the plant- or microbial-based oil is present in an amount between about 10% to about 30% w/w of the food product.

9. The food product of claim 1, wherein the food product is a cheese.

10. The food product of claim 1, wherein the fermented non-dairy nutrient base is a fermented plant milk or a fermented microbial-based milk comprising (i) water, and (ii) milled seeds, milled nuts, milled beans, milled grains, milled vegetables, or a combination thereof.

11. (canceled)

12. The food product of claim 10, wherein the fermented plant milk is selected from soybean milk, lupini bean milk, almond milk, hemp seed milk, melon seed milk, pumpkin seed milk, oat milk, pea milk, fava bean milk, chickpea milk, sunflower seed milk, edamame milk, lentil milk, pistachio milk, peanut milk, walnut milk, cashew milk, coconut milk, watermelon seed milk, and macadamia milk.

13. The food product of claim 1, wherein the hydrocolloid fiber is selected from a fiber extract from seaweed, a fiber extract from an algae, acacia gum, locust bean gum, guar gum, pectin, cellulose or a cellulose derivative, konjac, alginate, carrageenan, gellan gum, agar, pullulan, dextran, curdlan, levan, and xanthan; wherein the algae is selected from Rhodophyceae algae, Phaeophyceade algae, or Chlorophyceae algae; or wherein the hydrocolloid fiber is a fiber extract from a microorganism of a genus selected from Xanthomonas, Sphingomonas, Pseudomonas, Aureobasidium, Streptococcus, Leuconostoc, Acetobacter, Azotobacter, Pseudomonas, Alcaligenes, Bacillus, Zymomonas, Aerobacter, Acetobacter, Actinomyces, Erwinia, Rhanella, Lactobacillus, Microbacterium, and Serratia.

14-15. (canceled)

16. The food product of claim 1, wherein the hydrocolloid fiber forms a synergetic gel.

17. The food product of claim 1, wherein the hydrocolloid fiber is 1.0% w/w or less of the coagulated food product.

18. The food product of claim 1, wherein the non-dairy protein is present in an amount greater than or equal to 20% w/w.

19. The food product of claim 1, wherein (i) a protein isolate or a protein concentrate was not added to the non-dairy nutrient base or the food product; (ii) the food product is fully fermented; (iii) the fermented non-dairy nutrient base is fermented with mesophilic or thermophilic bacteria; (iv) or any combination of (i)-(iii).

20. The food product of claim 1, wherein the coagulated food comprises only whole plant foods as ingredients and consists of 8 or fewer ingredients.

21. (canceled)

22. The food product of claim 1, wherein:
(i) the food product has a complex modulus (G*) between about 30000 PA and about 50000 PA at a frequency of 2-20 HZ;
(ii) the food product has a phase angle (A) between about 8 and about 16 at a frequency of 2-20 HZ;
(iii) the food product has a cut force slope of less than 1.5 N/s; or
(iv) any combination of (i)-(iii).

23-26. (canceled)

27. A method of producing a food product, comprising:
(a) inoculating a non-dairy nutrient base with at least one microbial culture;
(b) adding at least one hydrocolloid fiber to the non-dairy nutrient base inoculated with the at least on microbial culture, thereby inducing coagulation and formation of a curd;
(c) removing water from the curd such that protein content of the curd is at least two times higher than protein content of the non-dairy nutrient base of a w/w basis; and
(d) aging the curd to allow fermentation of the non-dairy nutrient base by the with at least one microbial culture.

28-52. (canceled)

53. A method of solid-state fermentation, comprising:
coagulating a non-dairy nutrient base by contacting the non-dairy nutrient base with at least one hydrocolloid fiber to form a solid or gel and;
inoculating the non-dairy nutrient base with at least one microbial culture; and
incubating the solid or gel to allow fermentation of the non-dairy nutrient base by the at least one microbial culture in a solid-state.

54-61. (canceled)
